(19) United States
(12) Patent Application Publication
(10) Pub. No.: US 2012/0196142 A1
(43) Pub. Date: Aug. 2, 2012

(54) RESIN FILM, POLARIZER PROTECTIVE FILM, POLARIZER, AND LIQUID-CRYSTAL DISPLAY DEVICE

(75) Inventors: Nobutaka FUKAGAWA, Kanagawa (JP); Kengo ASAI, Kanagawa (JP); Akio TAMURA, Kanagawa (JP)

(73) Assignee: FUJIFILM CORPORATION, Tokyo (JP)

(21) Appl. No.: 13/360,316

(22) Filed: Jan. 27, 2012

(30) Foreign Application Priority Data
Jan. 28, 2011 (JP) 2011-016780

(51) Int. Cl. C08L 1/10; B32B 27/28

(52) U.S. Cl. 428/522; 524/37

(57) ABSTRACT

A resin film containing a cellulose acylate and at least one of a polymer or an oligomer having a cyano group-comprising recurring unit in an amount of from 1.5 to 300% by mass of the cellulose acylate has a small photoelastic coefficient and a small moisture content and is excellent in transparency.

### CROSS-REFERENCE TO RELATED APPLICATIONS

The present application claims the benefit of priority from Japanese Patent Application No. 2011-016780, filed on Jan. 28, 2011, the contents of which are herein incorporated by reference in their entirety.

### BACKGROUND OF THE INVENTION

1. Field of the Invention

The present invention relates to a resin film, a polarizer protective film, and a polarizer and a liquid-crystal display device using the polarizer protective film.

2. Description of the Related Art

With the recent tendency toward advanced upsizing of liquid-crystal display devices typically for use for televisions, much desired are high-quality picture technology and price reduction. In future, outdoor-use frequency of display devices typically for digital signage and others is expected to increase more and more, and liquid-crystal display devices capable of withstanding use under more extreme weather condition than before are desired.

The polarizer in a liquid-crystal display device that is widely used in the art is so designed that a polarizing element formed by using polyvinyl alcohol (PVA) and iodine is sandwiched between polarizer protective films such as cellulose acylate films, etc. In particular, cellulose acylate films are excellent in transparency and have a low haze, and are therefore favorably used as polarizer protective films. However, the polarizer has heretofore been said to be problematic in that, when used in high-temperature high-humidity environments, there tends to occur display unevenness. It has been considered that the display unevenness would be caused by the stress to occur when the polarizing element shrinks in high-temperature high-humidity environments in that the stress thus having occurred would propagate to the polarizer protective film to thereby change the retardation of the polarizer protective film.

Against the above, it is known that reduction in the photoelastic coefficient of the polarizer protective film is effective for overcoming the problem of display unevenness, and Patent Reference 1 discloses a method of adding a polymer compound prepared through copolymerization of N-vinyl-2-pyrrolidone and methyl methacrylate, to a cellulose ester film to reduce the photoelasticity of the film, thereby removing display unevenness. Patent Reference 2 discloses a film having a reduced photoelasticity, which is produced by adding a cycloolefin compound having a mass-average molecular weight of from 200 to 20,000 to a cellulose acylate film.

On the other hand, there are known some cases of adding a polymer of an ethylenic unsaturated monomer having a nitrogen atom in the side chain thereof, to a cellulose acylate film. For example, Patent Reference 3 describes a cellulose acylate film to which is added a polymer compound prepared through copolymerization of an ethylenic unsaturated monomer having an amide bond in the side chain thereof. Patent Reference 4 describes polyacrylonitrile as an example of a mat agent prepared by granulating a polymer compound according to various methods. In Patent Reference 4, the mat agent is added to an optical film in an amount falling within a range of from 0.03 to 1.0% by mass of the solid content of the film from the viewpoint of reducing the haze of the film. The patent reference says that the mat agent is added preferably to the skin layer alone.
[Patent Reference 1] JP-A 2009-126899
[Patent Reference 2] JP-A 2007-84800
[Patent Reference 3] WO2008/120595
[Patent Reference 4] JP-A 2008-26881

### SUMMARY OF THE INVENTION

However, the present inventors have found as a result of various investigations thereon that the methods described in Patent References 1 and 2 have some problems in that, according to the methods, the photoelastic coefficient could not be reduced sufficiently and the moisture content change in varying environmental humidity is great, and therefore the methods are ineffective for removing display unevenness, and are therefore desired to be improved.

An object of the present invention is to provide a resin film having a low photoelastic coefficient and a low moisture content and excellent in transparency.

### Means for Solving the Problems

The present inventors have found that, when a polymer having a cyano group in the side chain as the partial structure thereof is added to a cellulose acylate film, then the photoelastic coefficient of the film can be greatly lowered and the moisture content thereof can also be reduced and, in addition, the transparency of the film is excellent, and have completed the present invention.

Specifically, the invention includes the following constitutions:
[1] A resin film comprising:

a cellulose acylate and

a polymer or an oligomer having a cyano group-comprising recurring unit in an amount of from 1.5 to 300% by mass of the cellulose acylate.

[2] The resin film according to [1], wherein the weight-average molecular weight of the polymer or the oligomer having a cyano group-containing recurring unit is from 1000 to 100000.
[3] The resin film according to [1] or [2], wherein the polymer or the oligomer having a cyano group-containing recurring unit consist of one or more different types of cyano group-containing recurring units.
[4] The resin film according to [1] or [2], wherein the polymer or the oligomer having a cyano group-containing recurring unit comprises one or more different types of cyano group-containing recurring units and a recurring unit not containing a cyano group.
[5] The resin film according to any one of [1] to [4], wherein the cyano group-containing recurring unit includes a recurring unit derived from an ethylenic unsaturated monomer having a structure represented by the following formula (1):

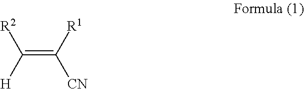

wherein R¹ and R² each independently represent a hydrogen atom, an alkyl group having from 1 to 6 carbon atoms, a halogen atom, a cyano group, an alkoxy group having from 1 to 6 carbon atoms, an acyl group having from 1 to 6 carbon atoms, —NH—COOH, an acylamino group having from 1 to 6 carbon atoms, or a carbamoyl group.
[6] The resin film according to [5], wherein the cyano group-containing recurring unit is a recurring unit derived from an ethylenic unsaturated monomer having the structure represented by the formula (1).
[7] The resin film according to any one of [1] to [6], wherein the polymer or oligomer has only one type of a cyano group-containing recurring unit.
[8] The resin film according to any one of [1] to [7], wherein the total degree of acyl substitution of the cellulose acylate is from 2.00 to 2.95.
[9] The resin film according to any one of [1] to [8], of which the absolute value of the photoelastic coefficient is at most 10×10⁻¹² m²/N, the haze is at most 1% and the moisture content at 25° C. and at a relative humidity of 80% is at most 5%.
[10] A polarizer protective film using the resin film of any one of [1] to [9].
[11] A polarizer containing a polarizing element and at least one polarizer protective film of [10].
[12] A liquid-crystal display device containing at least one of the polarizer protective film of [10] or the polarizer of [11].

According to the invention, there is obtained a resin film having a small photoelastic coefficient and a small moisture content and excellent in transparency. Further according to the invention, there are provided a polarizer protective film and a polarizer using the resin film and having high durability. When the polarizer using the film is incorporated in a liquid-crystal display device, there is provided a liquid-crystal display device capable of avoiding display unevenness.

### BRIEF DESCRIPTION OF DRAWINGS

FIG. 1 is a schematic cross-sectional view of one example of the liquid-crystal display device of the invention.

FIG. 2 is a schematic view showing one example of a casting mode to form a three-layer cellulose acylate film according to a simultaneous co-casting method using a co-casting die.

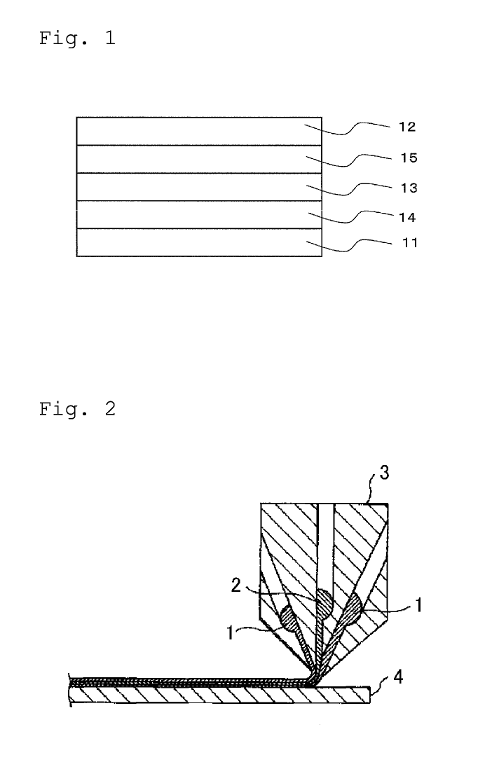

In the drawings, 1 is surface layer dope, 2 is core layer dope, 3 is co-casting giesser, 4 is casting support, 11 is polarizing element, 12 is polarizing element, 13 is liquid-crystal cell, 14 is polarizer protective film, and 15 is cellulose acylate film of examples and comparative examples.

### MODE FOR CARRYING OUT THE INVENTION

The resin film of the invention and its production method, and additives to be used for the film are described in detail hereinunder.

The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof. In this description, “polymer or oligomer” means that the term includes, in addition to a polymer of an ordinary high-molecular compound formed through polymerization or a large number of monomer molecules, an oligomer of a compound formed through polymerization of a few monomer molecules and having, for example, a molecular weight of 1000 or so.

### [Resin Film]

The resin film of the invention comprises a cellulose acylate and contains a polymer or an oligomer having a cyano group-containing recurring unit in an amount of from 1.5 to 300% by mass of the cellulose acylate.

Preferred embodiments of the resin film of the invention are described below.

### <Polymer or Oligomer Having Cyano Group-Containing Recurring Unit>

The polymer or oligomer having a cyano group-containing recurring unit, which the resin film of the invention contains, is described.

In the invention, the polymer or oligomer having a cyano group-containing recurring unit may be in the form of granules like those for use for a mat agent, or may be in any other form, for example, in the form of a powder. Above all, the polymer or oligomer having a cyano group-containing recurring unit is preferably in the form of a powder.

In case where the polymer or oligomer having a cyano group-containing recurring unit is produced through polymerization or copolymerization under ordinary conditions, it may be in the form a powder. Preferably, in the invention, the particle size of the polymer or oligomer having a cyano group-containing recurring unit is more powdery than that for use as a mat agent, and the particle size thereof can be so controlled as above by powdering the polymer or oligomer product in polymerization or copolymerization.

The polymer or oligomer having a cyano group-containing recurring unit can be obtained through polymerization or copolymerization of an ethylenic unsaturated monomer that contains a cyano group in the molecule as the partial structure thereof.

### (Cyano Group-Containing Recurring Unit)

In the polymer or oligomer having a cyano group-containing recurring unit, the cyano group-containing recurring unit is described. The cyano group-containing recurring unit may be a recurring unit formed through polymerization of an ethylenic unsaturated monomer that has a cyano group in the molecule as the partial structure thereof, or may also be a recurring unit formed by introducing a cyano group as a substituent to the recurring unit formed through polymerization of an ethylenic unsaturated monomer not having a cyano group in the molecule as the partial structure thereof. Above all, the cyano group-containing recurring unit is preferably the former one formed through polymerization of an ethylenic unsaturated monomer that has a cyano group in the molecule as the partial structure thereof.

The ethylenic unsaturated monomer that has a cyano group in the molecule as the partial structure thereof is described in detail hereunder.

The ethylenic unsaturated monomer that has a cyano group in the molecule as the partial structure thereof is not specifically defined in point of the ethylenic unsaturated structure thereof. Specific examples of the ethylenic unsaturated structure include a vinyl group, an allyl group, an acryloyl group, a methacryloyl group, a styryl group, an acrylamide group, a methacrylamide group, a vinyl cyanide group, a 2-cyanoacryloxy group, a 1,2-epoxy group, a vinylbenzyl group, a vinyl ether group, etc. Preferred is a vinyl cyanide group. The ethylenic unsaturated monomer that has a cyano group in the molecule as the partial structure thereof may have one or more cyano groups in the molecule. In this, the cyano group may be a substituent that directly bonds to the main chain of the polymer formed through polymerization of the ethylenic unsaturated monomer that has a cyano group in the molecule as the partial structure thereof, or may also be a substituent that bonds to the main chain thereof via a linking group therebetween. Above all, preferably, the ethylenic unsaturated monomer has one cyano group in the molecule as the partial structure thereof and the cyano group in this is to be a substituent that directly bonds to the main chain of the polymer formed through polymerization of the ethylenic unsaturated monomer that has a cyano group in the molecule as the partial structure thereof. Not adhering to any theory, in case where the polymer formed through polymerization of the ethylenic unsaturated monomer that has a cyano group in the molecule as the partial structure thereof has a compact side chain having a large polarizability, the resin film containing the polymer of the type can have a lowered photoelectric elasticity.

The polymer or oligomer having a cyano group-containing recurring unit may be composed of one or more different types of cyano group-containing recurring units alone, or may comprise one or more different types of cyano group-containing recurring units and a recurring unit not containing a cyano group. Preferably, the polymer or oligomer having a cyano group-containing recurring unit is composed of one or more different types of cyano group-containing recurring units alone from the viewpoint of reducing the photoelastic coefficient of the resin film. On the other hand, also preferably, the polymer or oligomer having a cyano group-containing recurring unit comprises one or more different types of cyano group-containing recurring units and a recurring unit not containing a cyano group from the viewpoint of securing the compatibility thereof with cellulose acylate.

In the polymer or oligomer having a cyano group-containing recurring unit, the cyano group-containing recurring unit may be a recurring unit derived from an ethylenic unsaturated monomer having a structure represented by the following formula (1), or may be one derived from an ethylenic unsaturated monomer having any other skeleton. In the invention, preferably, the cyano group-containing recurring unit includes a recurring unit derived from an ethylenic unsaturated monomer having a structure represented by the following formula (1). In other words, more preferably, the ethylenic unsaturated monomer having a cyano group in the molecule as the partial structure thereof is represented by the following formula (1):

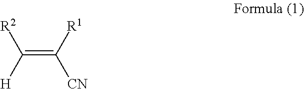

In the formula, R¹ and R² each independently represent a hydrogen atom, an alkyl group having from 1 to 6 carbon atoms, a halogen atom, a cyano group, an alkoxy group having from 1 to 6 carbon atoms, an acyl group having from 1 to 6 carbon atoms, —NH—COOH, an acylamino group having from 1 to 6 carbon atoms, or a carbamoyl group.

R¹ is preferably a hydrogen atom, a methyl group, an ethyl group, a chlorine atom or a cyano group, and most preferably a methyl group.

R² is preferably a hydrogen atom, a methyl group or a cyano group, and most preferably a hydrogen atom.

As the ethylenic unsaturated monomer having a cyano group in the molecule as the partial structure thereof, especially preferred is methacrylonitrile.

Further in the invention, the cyano group-containing recurring unit in the polymer or oligomer having a cyano group-containing recurring unit is more preferably a recurring unit derived from an ethylenic unsaturated monomer having a structure represented by the above-mentioned formula (1). In other words, more preferably, the polymer or oligomer having a cyano group-containing recurring unit does not contain a recurring unit derived from an ethylenic unsaturated monomer having any other skeleton than the structure represented by the above-mentioned formula (1), as the cyano group-containing recurring unit therein.

In case where the cyano group-containing recurring unit in the polymer or oligomer having a cyano group-containing recurring unit contains a recurring unit derived from an ethylenic unsaturated monomer having any other skeleton than the structure represented by the above-mentioned formula (1), usable as the ethylenic unsaturated monomer having the other skeleton is an ethylenic unsaturated monomer represented by the formula (2) to be mentioned below where R³ and R⁴ each are a substituent containing a cyano group, or represented by the formula (4) to be mentioned below where R⁷, R⁸ and R⁹ each are a substituent containing a cyano group.

One or more different types of ethylenic unsaturated monomers having a cyano group in the molecule as the partial structure thereof mentioned above can be used here either singly or as combined. Specifically, the polymer or oligomer having a cyano group-containing recurring unit may contain only one type or two or more different types of cyano group-containing recurring units. Accordingly, the polymer or oligomer having a cyano group-containing recurring unit may be a homopolymer of one type alone of an ethylenic unsaturated monomer having a cyano group in the molecule as the partial structure thereof, or may also be a copolymer produced through copolymerization of a combination of two or more different types of ethylenic unsaturated monomers having a cyano group in the molecule as the partial structure thereof.

Above all, preferably, the polymer or oligomer contains only one type of a cyano group-containing recurring unit.

In case where the polymer or oligomer is not a copolymer with any other ethylenic unsaturated monomer to be mentioned below, preferably, the polymer or oligomer produced through polymerization of an ethylenic unsaturated monomer having a cyano group as the partial structure thereof is a homopolymer of one type alone of an ethylenic unsaturated monomer having a cyano group in the molecule as the partial structure thereof.

The ethylenic unsaturated monomer having a cyano group in the molecule as the partial structure thereof for use in the invention may be a commercially-available one or may be produced with reference to known literature.

### (Recurring Unit not Containing Cyano Group)

Next described is the recurring unit not containing a cyano group, which the polymer or oligomer having a cyano group-containing recurring unit may contain. The recurring unit not containing a cyano group is preferably a recurring unit formed through polymerization of any other ethylenic unsaturated monomer not having a cyano group in the molecule as the partial structure thereof (hereinafter this may be referred to as the other ethylenic unsaturated monomer).

The other ethylenic unsaturated monomer to be copolymerized with the ethylenic unsaturated monomer having a cyano group in the molecule as the partial structure thereof is described in detail.

### (1) Acrylate Monomer:

The other ethylenic unsaturated monomer is preferably an acrylate monomer. The acrylate monomer includes (meth)acrylates, for example, methyl (meth)acrylate, ethyl (meth)acrylate, propyl (meth)acrylate, chloroethyl (meth)acrylate, 2-hydroxyethyl (meth)acrylate, trimethylolpropane mono(meth)acrylate, benzyl (meth)acrylate, methoxybenzyl (meth)acrylate, furfuryl (meth)acrylate, tetrahydrofurfuryl (meth)acrylate, ethyl acetacetate (meth)acrylate, etc. Especially preferred are methyl (meth)acrylate monomer and ethyl acetacetate (meth)acrylate.

### (2) Monomer Represented by the Following Formula (2):

A monomer represented by the following formula (2) is also preferred as the other ethylenic unsaturated monomer.

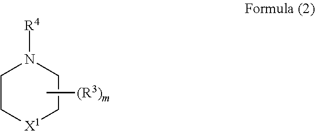

In the formula (2), R³ represents a hydrogen atom, an oxygen atom, a halogen atom, an aliphatic group optionally having a substituent, an aromatic group optionally having a substituent, or a heterocyclic group optionally having a substituent; m indicates an integer of from 0 to 8, and when m is from 2 to 8, R³'s may be the same or different; R⁴ represents a group having an ethylenic unsaturated bond as the partial structure thereof; and X¹ represents an oxygen atom or a sulfur atom.

Not specifically defined, the group to be represented by R³ includes, for example, an alkyl group (e.g., methyl group, ethyl group, propyl group, isopropyl group, t-butyl group, pentyl group, hexyl group, octyl group, dodecyl group, trifluoromethyl group, etc.), a cycloalkyl group (e.g., cyclopentyl group, cyclohexyl group, etc.), an aryl group (e.g., phenyl group, naphthyl group, etc.), an acylamino group (e.g., acetylamino group, benzoylamino group, etc.), an alkylthio group (e.g., methylthio group, ethylthio group, etc.), an arylthio group (e.g., phenylthio group, naphthylthio group, etc.), an alkenyl group (e.g., vinyl group, 2-propenyl group, 3-butenyl group, 1-methyl-3-propenyl group, 3-pentenyl group, 1-methyl-3-butenyl group, 4-hexenyl group, cyclohexenyl group, etc.), a halogen atom (e.g., fluorine atom, chlorine atom, bromine atom, iodine atom, etc.), an alkynyl group (e.g., propargyl group, etc.), a heterocyclic group (e.g., pyridyl group, thiazolyl group, oxazolyl group, imidazolyl group, etc.), an alkylsulfonyl group (e.g., methylsulfonyl group, ethylsulfonyl group, etc.), an arylsulfonyl group (e.g., phenylsulfonyl group, naphthylsulfonyl group, etc.), an alkylsulfinyl group (e.g., methylsulfinyl group, etc.), an arylsulfinyl group (e.g., phenylsulfinyl group, etc.), a phosphono group, an acyl group (e.g., acetyl group, pivaloyl group, benzoyl group, etc.), a carbamoyl group (e.g., aminocarbonyl group, methylaminocarbonyl group, dimethylaminocarbonyl group, butylaminocarbonyl group, cyclohexylaminocarbonyl group, phenylaminocarbonyl group, 2-pyridylaminocarbonyl group, etc.), a sulfamoyl group (e.g., aminosulfonyl group, methylaminosulfonyl group, dimethylaminosulfonyl group, butylaminosulfonyl group, hexylaminosulfonyl group, cyclohexylaminosulfonyl group, octylaminosulfonyl group, dodecyaminosulfonyl group, phenylaminosulfonyl group, naphthylaminosulfonyl group, 2-pyridylaminosulfonyl group, etc.), a sulfonamide group (e.g., methanesulfonamide group, benzenesulfonamide group, etc.), an alkoxy group (e.g., methoxy group, ethoxy group, propoxy group, etc.), an aryloxy group (e.g., phenoxy group, naphthyloxy group, etc.), a heterocyclic-oxy group, a siloxy group, an acyloxy group (e.g., acetyloxy group, benzoyloxy group, etc.), a sulfonic acid group, a sulfonate salt group, an aminocarbonyloxy group, an amino group (e.g., amino group, ethylamino group, dimethylamino group, butylamino group, cyclopentylamino group, 2-ethylhexylamino group, dodecylamino group, etc.), an anilino group (e.g., phenylamino group, chlorophenylamino group, toluidino group, anisidino group, naphthylamino group, 2-pyridylamino group, etc.), an imide group, an ureido group (e.g., methylureido group, ethylureido group, pentylureido group, cyclohexylureido group, octylureido group, dodecylureido group, phenylureido group, naphthylureido group, 2-pyridylaminoureido group, etc.), an alkoxycarbonylamino group (e.g., methoxycarbonylamino group, phenoxycarbonylamino group, etc.), an alkoxycarbonyl group (e.g., methoxycarbonyl group, ethoxycarbonyl group, phenoxycarbonyl group, etc.), an aryloxycarbonyl group (e.g., phenoxycarbonyl group, etc.), a heterocyclic-thio group, a thioureido group, a carboxyl group, a carboxylate salt group, a hydroxyl group, a mercapto group, a nitro group, etc. These substituents may be further substituted with substituents similar thereto.

R⁴ has an ethylenic unsaturated bond, concretely including a vinyl group, an allyl group, an acryloyl group, a methacryloyl group, a styryl group, an acrylamide group, a methacrylamide group, a 1,2-epoxy group, a vinylbenzyl group, a vinyl ether group, etc. Preferred are a vinyl group, an acryloyl group, a methacryloyl group, an acrylamide group, and a methacrylamide group.

Preferred examples of the ethylenic unsaturated monomer having a partial structure represented by the above-mentioned formula (2) in the molecule thereof for use in the invention are shown below, to which, however, the invention is not limited.

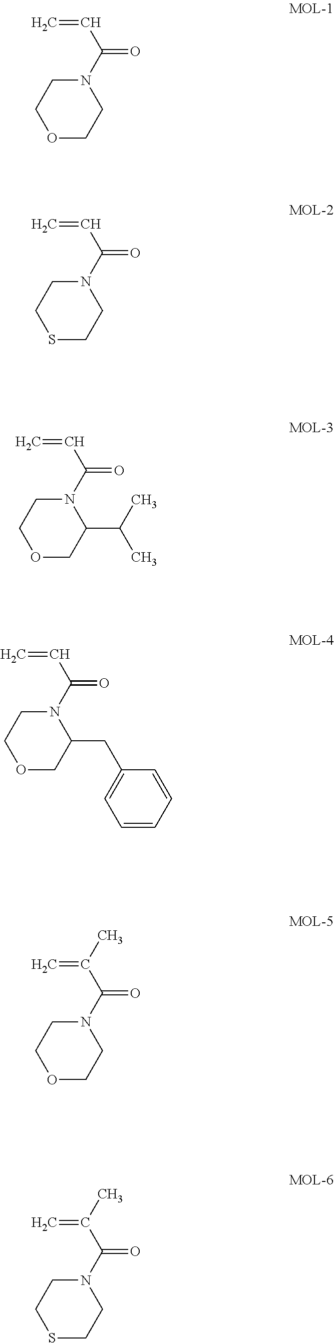

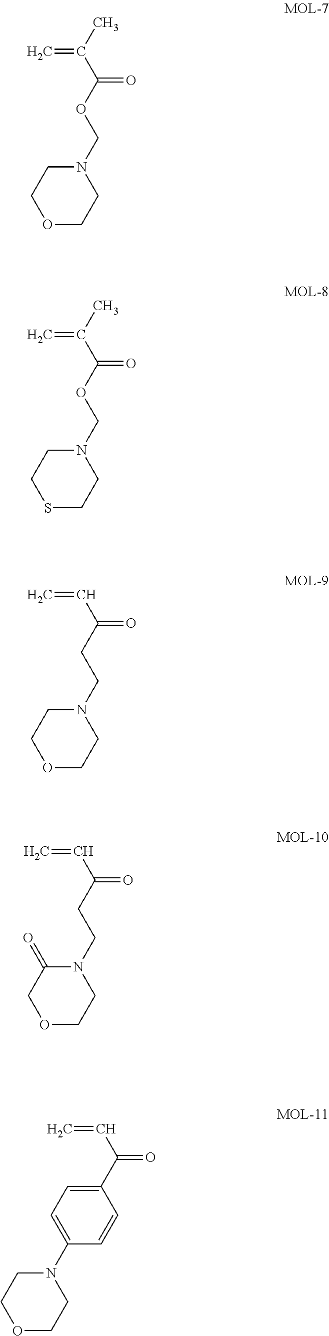

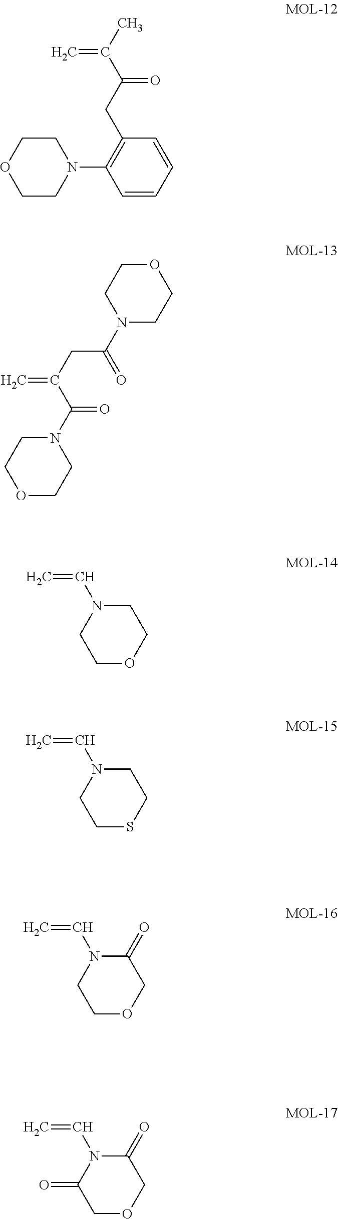

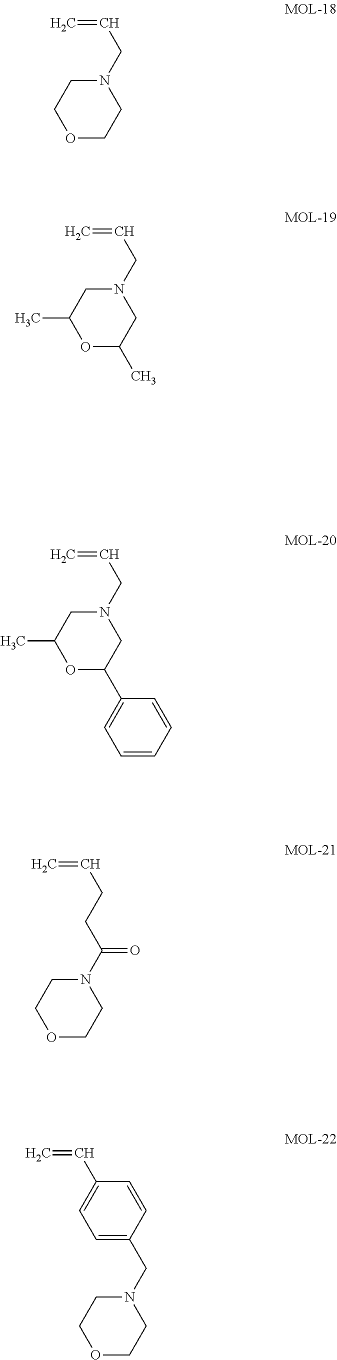

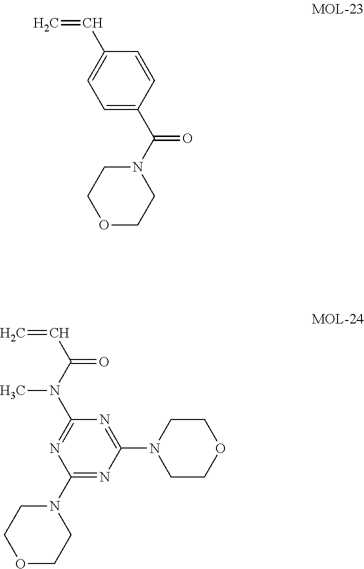

Either singly or as combined, one or more of the ethylenic unsaturated monomers having a partial structure represented by the above-mentioned formula (2) in the molecule thereof may be used in the invention along with the ethylenic unsaturated monomer having a cyano group in the molecule as the partial structure thereof.

As the ethylenic unsaturated monomers having a partial structure represented by the above-mentioned formula (2), especially preferred is N-methacryloylmorpholine or N-acryloylmorpholine, and more preferred is N-acryloylmorpholine.

### (3) Beta-Ketoester Monomer:

A monomer represented by the following formula (3) is also preferred as the other ethylenic unsaturated monomer.

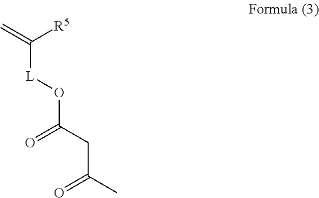

In the formula (3), R⁵ represents a hydrogen atom, an aliphatic group, an aromatic group or a heterocyclic group, and the aliphatic group, the aromatic group and the heterocyclic group may have a substituent; L represents a single bond, or a divalent aliphatic group, a divalent aromatic group, a divalent heterocyclic group, —C(═O)—, —O—, —N(R⁶)— or their combination, and the divalent aliphatic group, the divalent aromatic group and the divalent heterocyclic group may have a substituent; R⁶ represents a hydrogen atom or an alkyl group.

R⁵ in the formula (3) represents a hydrogen atom, an aliphatic group, an aromatic group or a heterocyclic group, and the aliphatic group, the aromatic group and the heterocyclic group may have a substituent.

The aliphatic group of R⁵ includes an alkyl group, an alkenyl group, an alkynyl group, a cycloalkyl group, etc. Of those, preferred is an alkyl group having from 1 to 6 carbon atoms, and more preferred is a methyl group.

The aromatic group of R⁵ includes a phenyl group, a naphthyl group, and a biphenyl group. Of those, preferred is a phenyl group.

The heterocyclic group includes a pyridyl group, a pyrrolidyl group, a piperidyl group, a piperazyl group, a pyrrolyl group, a morpholino group, a thiamorpholino group, an imidazolyl group, a pyrazolyl group, a pyrrolidonyl group, and a piperidonyl group. Of those, preferred are a morpholino group and a pyridyl group.

As the substituent which the aliphatic group, the aromatic group or the heterocyclic group may have, for example, there may be mentioned an alkyl group having from to 6 carbon atoms (e.g., methyl group, ethyl group, isopropyl group, tert-butyl group, cyclopentyl group, cyclohexyl group, etc.), an alkenyl group having from 2 to 6 carbon atoms (e.g., vinyl group, allyl group, 2-butenyl group, 3-pentenyl group, etc.), an alkynyl group having from 2 to 6 carbon atoms (e.g., propargyl group, 3-pentynyl group, etc.), an amino group (e.g., amino group, methylamino group, dimethylamino group, diethylamino group, dibenzylamino group, etc.), an alkoxy group (e.g., methoxy group, ethoxy group, butoxy group, etc.), an aryloxy group (e.g., phenyloxy group, 2-naphthyloxy group, etc.), an acyl group (e.g., acetyl group, benzoyl group, formyl group, pivaloyl group, etc.), an alkoxycarbonyl group (e.g., methoxycarbonyl group, ethoxycarbonyl group, etc.), an aryloxycarbonyl group (e.g., phenyloxycarbonyl group, etc.), an acyloxy group (e.g., acetoxy group, benzoyloxy group, etc.), an acylamino group (e.g., acetylamino group, benzoylamino group, etc.), an alkoxycarbonylamino group (e.g., methoxycarbonylamino group, etc.), an aryloxycarbonylamino group (e.g., phenyloxycarbonylamino group, etc.), a sulfonylamino group (e.g., methanesulfonylamino group, benzenesulfonylamino group, etc.), a sulfamoyl group (e.g., sulfamoyl group, methylsulfamoyl group, dimethylsulfamoyl group, phenylsulfamoyl group, etc.), a carbamoyl group (e.g., carbamoyl group, methylcarbamoyl group, diethylcarbamoyl group, phenylcarbamoyl group, etc.), an alkylthio group (e.g., methylthio group, ethylthio group, etc.), an arylthio group (e.g., phenylthio group, etc.), a sulfonyl group (e.g., mesyl group, tosyl group, etc.), a sulfinyl group (e.g., methanesulfinyl group, benzenesulfinyl group, etc.), an ureido group (e.g., ureido group, methylureido group, phenylureido group, etc.), a phosphoramido group (e.g., diethylphosphoramido group, phenylphosphoramido group, etc.), a hydroxyl group, a mercapto group, a halogen atom (e.g., fluorine atom, chlorine atom, bromine atom, iodine atom, etc.), a cyano group, a sulfo group, a carboxyl group, a nitro group, a hydroxamic acid group, a sulfino group, a hydrazino group, an imino group, a heterocyclic group (e.g., imidazolyl group, pyridyl group, quinolyl group, furyl group, piperidyl group, morpholino group, benzoxazolyl group, benzimidazolyl group, benzothiazolyl group, etc.), a silyl group (e.g., trimethylsilyl group, triphenylsilyl group, etc.). These substituents may be further substituted. In case where the group is substituted with two substituents, they may be the same or different. If possible, the substituents may bond to each other to form a ring. Above all, preferred are a methyl group and a fluoro group.

Preferably, R⁵ in the formula (3) is a hydrogen atom or an aliphatic group, more preferably a hydrogen atom or an alkyl group having from 1 to 6 carbon atoms, even more preferably a hydrogen atom or a methyl group, still more preferably a methyl group.

In the formula (3), L is a single bond, a divalent aliphatic group, a divalent aromatic group, a divalent heterocyclic group, —C(═O)—, —O—, —N(R⁶)— or their combination, and the divalent aliphatic group, the divalent aromatic group and the divalent heterocyclic group may have a substituent.

L is preferably a divalent aliphatic group, a divalent aromatic group, —C(═O)—, or -L¹-L²-, in which one of L¹ and L² is —C(═O)—, —O—, —N(R²)— or their combination, and the other is a divalent aliphatic group, a divalent aromatic group or a divalent heterocyclic group. The divalent aliphatic group, the divalent aromatic group and the divalent heterocyclic group may have a substituent. R² represents a hydrogen atom or an alkyl group. In -L¹-L²-, L¹ bonds to the main chain.

Preferably, L is -L¹-L²-.

In L, more preferably, L¹ is —C(═O)—, —O—, —N(R²)— or their combination, and L² is a divalent aliphatic group, a divalent aromatic group, or a divalent heterocyclic group.

The divalent aliphatic group for L is preferably an alkylene group or an alkynylene group, more preferably an alkylene group having from 1 to 5 carbon atoms and optionally having a substituent, even more preferably an ethylene group.

The divalent aromatic group for L is preferably an aromatic group having from 6 to 12 carbon atoms, more preferably a phenylene group or a naphthylene group, even more preferably a phenylene group optionally having a substituent, still more preferably an unsubstituted phenylene group.

The divalent heterocyclic group for L includes a pyridylene group, a pyrrolydilene group, a piperidylene group, a piperazylene group, a pyrrolylene group, a morpholinylene group, a thiamorpholinylene group, a imidazolylene group, a pyrazolylene group, a pyrrolidonylene group, and a piperidonylene group. Of those, preferred is a morpholinylene group.

The substituent which the divalent aliphatic group, the divalent aromatic group and the divalent heterocyclic group may have includes, for example, an alkyl group and a halogen group. Of those, preferred is an alkyl group, more preferred is an alkyl group having from 1 to 6 carbon atoms, and even more preferred is a methyl group.

Preferably, L¹ is —C(═O)—, —O—, —N(R²)— or their combination. As —C(═O)—, —O—, —N(R²)— or their combination, preferred are —C(═O)—, —O—, —C(═O)—O—, —O—C(═O)—, —N(R²)—C(═O)—, —C(═O)—N(R²)—, and —N(R²)—C(═O)—N(R²)—. More preferably, L¹ is —C(═O)—O— or —C(═O)—N(R²)—, even more preferably —C(═O)—O—.

L² is preferably a divalent aliphatic group, a divalent aromatic group or a divalent heterocyclic group, more preferably an alkylene group having from 1 to 5 carbon atoms and optionally having a substituent, or a phenylene group, even more preferably an alkylene group having from 1 to 5 carbon atoms and optionally having a substituent, still more preferably an ethylene group.

The preferred range of the divalent aliphatic group, the divalent aromatic group and the divalent heterocyclic group of L¹ and L² is the same as the preferred range of the divalent aliphatic group, the divalent aromatic group and the divalent heterocyclic group of L mentioned above.

A preferred combination of R⁵ and L in the formula (3) is an embodiment where R⁵ in the formula (3) is a hydrogen atom or a methyl group and L is a divalent aliphatic group, a divalent aromatic group, —C(═O)— or -L¹-L²-.

More preferably, R⁵ in the formula (3) is a hydrogen atom or a methyl group and L is -L¹-L²-.

Even more preferably, R⁵ is a hydrogen atom or a methyl group, and L¹ is —C(═O)—O— and L² is an alkylene group having from 1 to 5 carbon atoms and optionally having a substituent.

Still more preferably, R⁵ is a hydrogen atom or a methyl group, and L¹ is —C(═O)—O— and L² is an ethylene group. In other words, more preferred is an embodiment where the ethylenic unsaturated monomer represented by the formula (3) is ethyl acetacetate methacrylate or ethyl acetacetate acrylate.

Further, an embodiment where R⁵ in the formula (3) is a methyl group is even more preferred, or in other words, even more preferred is an embodiment where the ethylenic unsaturated monomer represented by the formula (3) is ethyl acetacetate methacrylate.

R⁶ is a hydrogen atom or an alkyl group.

Preferably, R⁶ is a hydrogen atom or an alkyl group having from 1 to 6 carbon atoms, more preferably a hydrogen atom or a methyl group, even more preferably a hydrogen atom.

### (4) Ethylenic Unsaturated Monomer Having Partial Structure Represented by the Following Formula (4):

An ethylenic unsaturated monomer having a partial structure represented by the following formula (4) is also preferred as the other ethylenic unsaturated monomer.

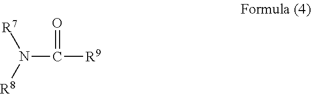

In the formula (4), R⁷, R⁸ and R⁹ each independently represent an aliphatic group optionally having a substituent, an aromatic group optionally having a substituent, or a heterocyclic group optionally having a substituent. Any two of R⁷, R⁸ and R⁹ may bond to each other to form a cyclic structure along with the nitrogen atom, or the nitrogen atom and the carbon atom to which they bond. The aliphatic group optionally having a substituent, the aromatic group optionally having a substituent or the heterocyclic group optionally having a substituent represented by R⁷, R⁸ and R⁹ is not specifically defined. For example, the groups include an alkyl group (e.g., methyl group, ethyl group, propyl group, isopropyl group, t-butyl group, pentyl group, hexyl group, octyl group, dodecyl group, trifluoromethyl group, etc.), a cycloalkyl group (e.g., cyclopentyl group, cyclohexyl group, etc.), an aryl group (e.g., phenyl group, naphthyl group, etc.), an acylamino group (e.g., acetylamino group, benzoylamino group, etc.), an alkylthio group (e.g., methylthio group, ethylthio group, etc.), an arylthio group (e.g., phenylthio group, naphthylthio group, etc.), an alkenyl group (e.g., vinyl group, 2-propenyl group, 3-butenyl group, 1-methyl-3-propenyl group, 3-pentenyl group, 1-methyl-3-butenyl group, 4-hexenyl group, cyclohexenyl group, etc.), a halogen atom (e.g., fluorine atom, chlorine atom, bromine atom, iodine atom, etc.), an alkynyl group (e.g., propargyl group, etc.), a heterocyclic group (e.g., pyridyl group, thiazolyl group, oxazolyl group, imidazolyl group, etc.), an alkylsulfonyl group (e.g., methylsulfonyl group, ethylsulfonyl group, etc.), an arylsulfonyl group (e.g., phenylsulfonyl group, naphthylsulfonyl group, etc.), an alkylsulfinyl group (e.g., methylsulfinyl group, etc.), an arylsulfinyl group (e.g., phenylsulfinyl group, etc.), a phosphono group, an acyl group (e.g., acetyl group, pivaloyl group, benzoyl group, etc.), a carbamoyl group (e.g., aminocarbonyl group, methylaminocarbonyl group, dimethylaminocarbonyl group, butylaminocarbonyl group, cyclohexylaminocarbonyl group, phenylaminocarbonyl group, 2-pyridylaminocarbonyl group, etc.), a sulfamoyl group (e.g., aminosulfonyl group, methylaminosulfonyl group, dimethylaminosulfonyl group, butylaminosulfonyl group, hexylaminosulfonyl group, cyclohexylaminosulfonyl group, octylaminosulfonyl group, dodecyaminosulfonyl group, phenylaminosulfonyl group, naphthylaminosulfonyl group, 2-pyridylaminosulfonyl group, etc.), a sulfonamide group (e.g., methanesulfonamide group, benzenesulfonamide group, etc.), an alkoxy group (e.g., methoxy group, ethoxy group, propoxy group, etc.), an aryloxy group (e.g., phenoxy group, naphthyloxy group, etc.), a heterocyclic-oxy group, a siloxy group, an acyloxy group (e.g., acetyloxy group, benzoyloxy group, etc.), a sulfonic acid group, a sulfonate salt group, an aminocarbonyloxy group, an amino group (e.g., amino group, ethylamino group, dimethylamino group, butylamino group, cyclopentylamino group, 2-ethylhexylamino group, dodecylamino group, etc.), an anilino group (e.g., phenylamino group, chlorophenylamino group, toluidino group, anisidino group, naphthylamino group, 2-pyridylamino group, etc.), an imide group, an ureido group (e.g., methylureido group, ethylureido group, pentylureido group, cyclohexylureido group, octylureido group, dodecylureido group, phenylureido group, naphthylureido group, 2-pyridylaminoureido group, etc.), an alkoxycarbonylamino group (e.g., methoxycarbonylamino group, phenoxycarbonylamino group, etc.), an alkoxycarbonyl group (e.g., methoxycarbonyl group, ethoxycarbonyl group, phenoxycarbonyl group, etc.), an aryloxycarbonyl group (e.g., phenoxycarbonyl group, etc.), a heterocyclic-thio group, a thioureido group, a carboxyl group, a carboxylate salt group, a hydroxyl group, a mercapto group, a nitro group, etc. These substituents may be further substituted with substituents similar thereto.

In the invention, any two of R⁷, R⁸ and R⁹ may bond to each other to form a cyclic structure, preferably a 5- to 7-membered cyclic structure along with the nitrogen atom, or the nitrogen atom and the carbon atom to which they bond. In such a case, the ring may further have a nitrogen atom, a sulfur atom or an oxygen atom in the ring, and the ring includes a saturated or unsaturated single ring, a multi-ring or a condensed ring. Concrete examples of the ring are hetero rings such as a pyrrolidine ring, a piperidine ring, a piperazine ring, a pyrrole ring, a morpholine ring, a thiamorpholine ring, an imidazole ring, a pyrazole ring, a pyrrolidone ring, a piperidone ring, etc. These rings may be further substituted with a substituent, and the substituent includes those by which R⁷, R⁸ and R⁹ may be substituted as mentioned above.

The ethylenic unsaturated monomer having a partial structure represented by the formula (4) in the molecule thereof for use in the invention has an ethylenic unsaturated bond in the molecule of the monomer; and this means that at least one group represented by R⁷, R⁸ and R⁹ is an alkenyl group as the group having an ethylenic unsaturated bond, or at least one group represented by R⁷, R⁸ and R⁹ has an ethylenic unsaturated bond as the partial structure thereof. Specific example of the ethylenic unsaturated bond include a vinyl group, an allyl group, an acryloyl group, a methacryloyl group, a styryl group, an acrylamide group, a methacrylamide group, a 1,2-epoxy group, a vinylbenzyl group, a vinyl ether group, etc. Preferred are a vinyl group, an acryloyl group, a methacryloyl group, an acrylamide group and a methacrylamide group.

Preferred examples of the ethylenic unsaturated monomer having a partial structure represented by the above-mentioned formula (4) in the molecule thereof are mentioned below, to which, however, the invention is not limited.

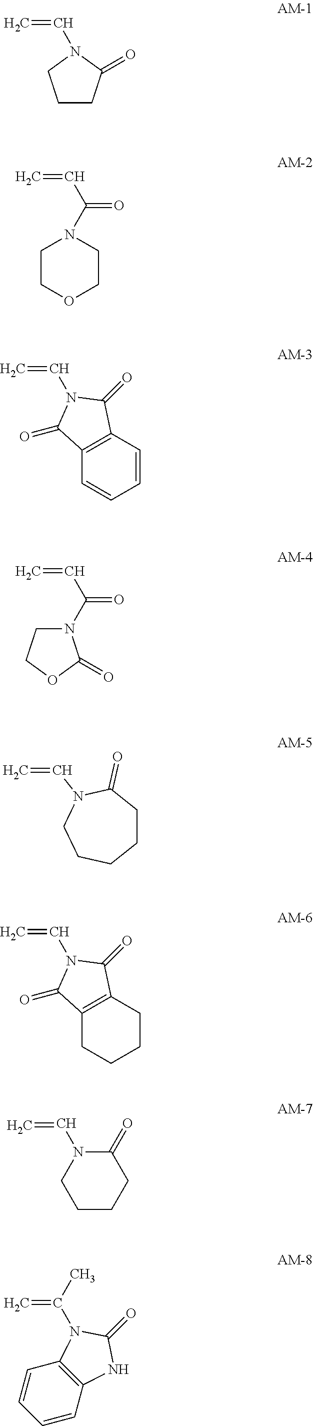

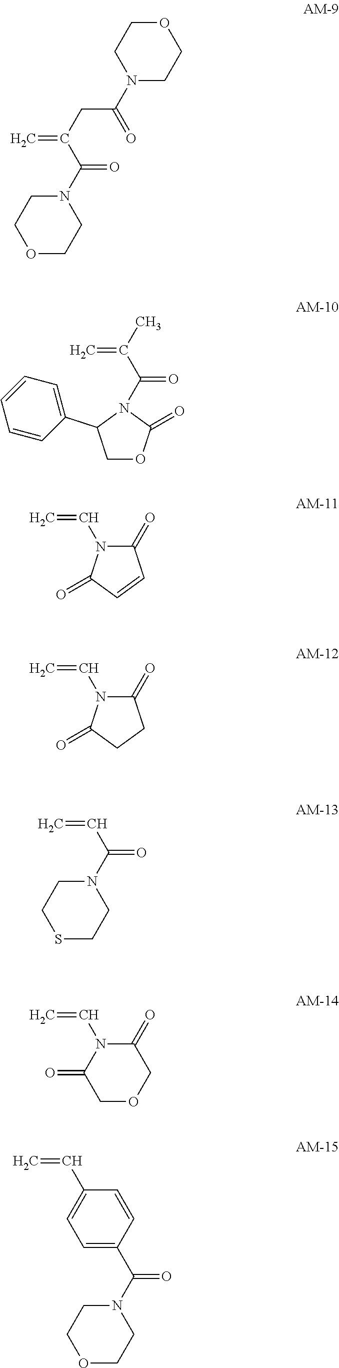

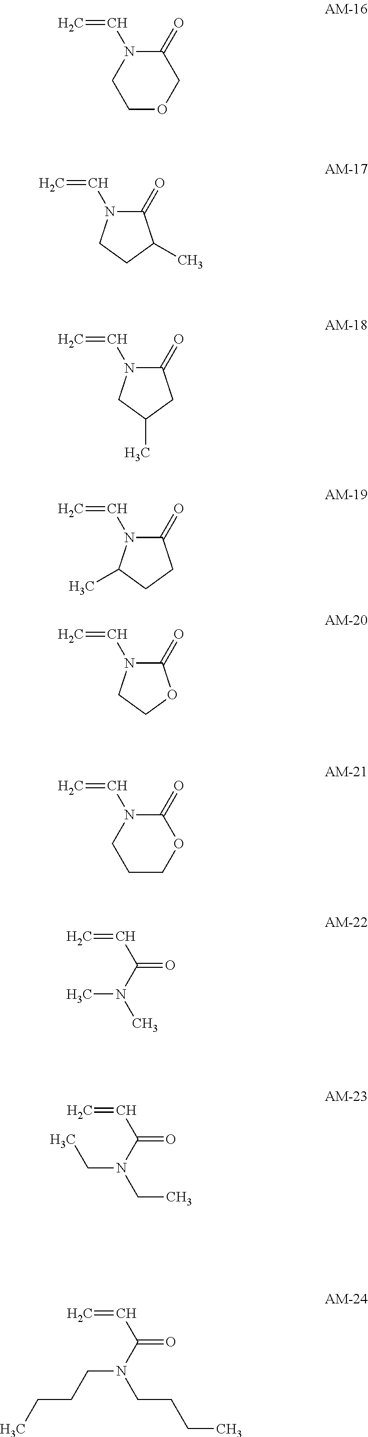

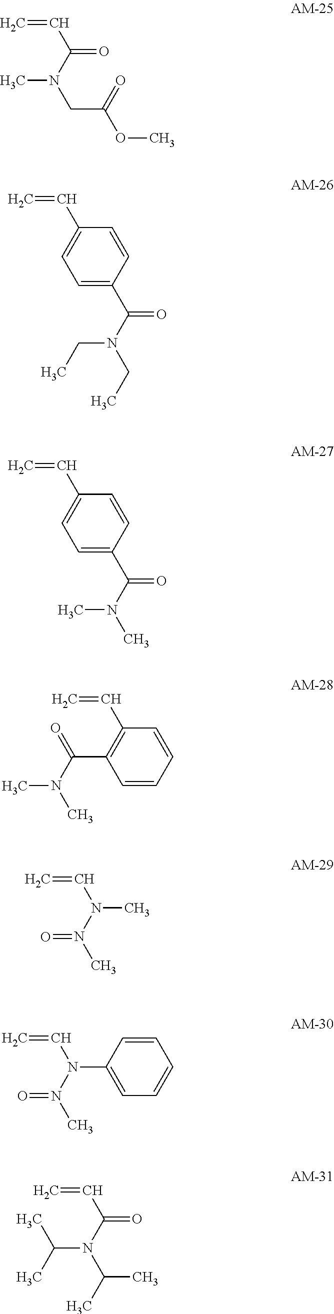

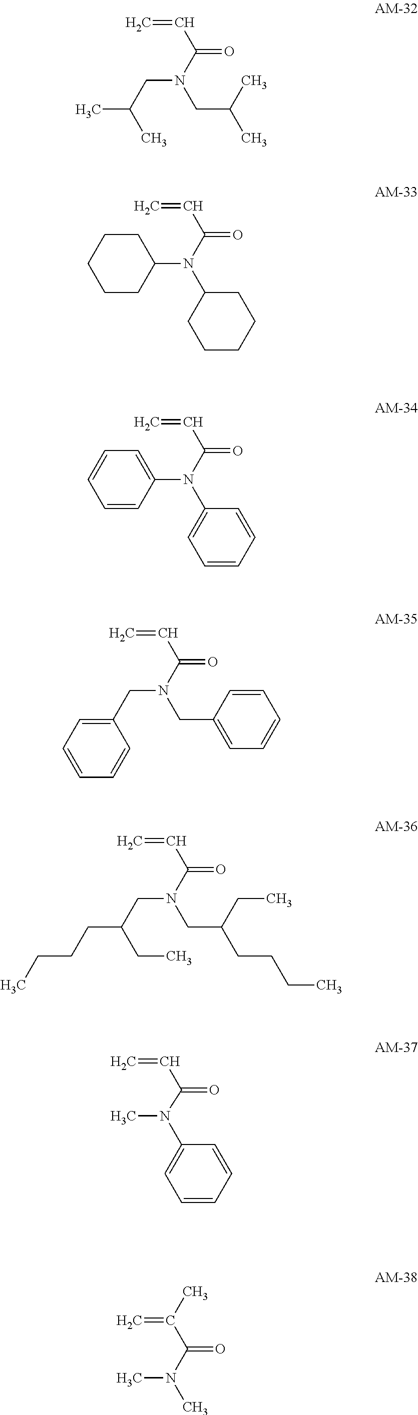

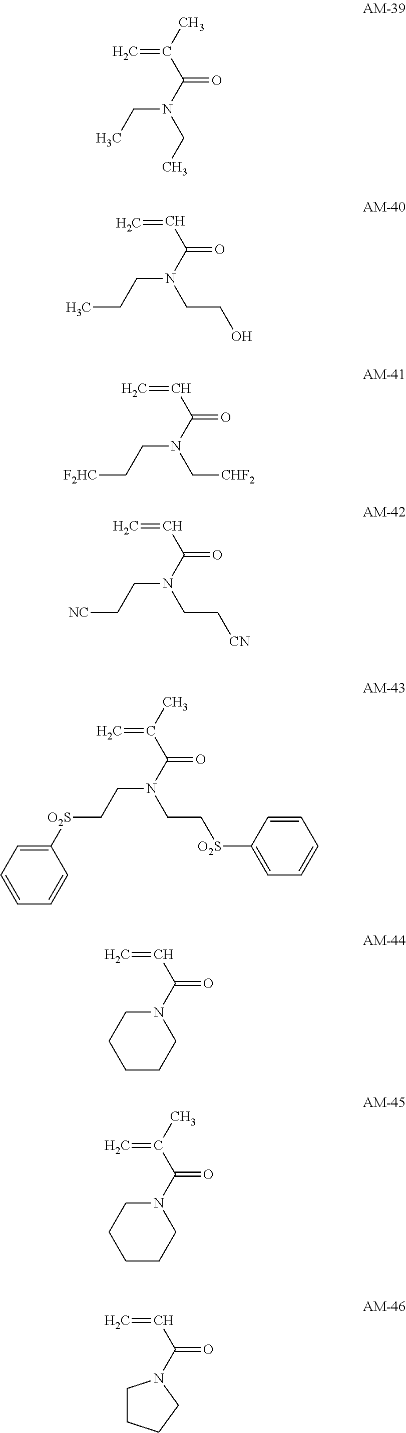

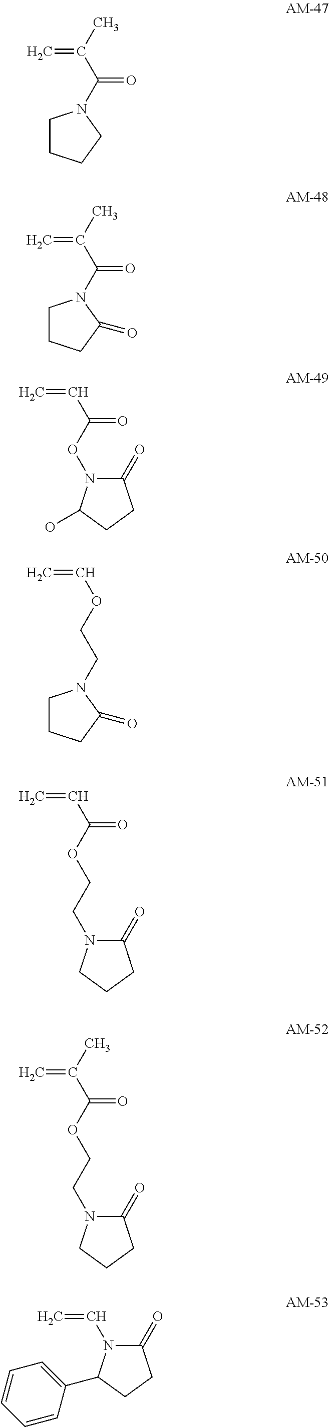

Either singly or as combined, one or more of those ethylenic unsaturated monomers having a partial structure represented by the formula (4) in the molecule thereof can be used here; and more preferred is use of N-vinylpyrrolidone, N-acryloylmorpholine, N-vinylpiperidone, N-vinylcaprolactam or their mixture.

The ethylenic unsaturated monomer having a partial structure represented by the formula (4) in the molecule thereof for use in the invention may be a commercially-available one or may be produced with reference to known literature.

### (Configuration of Polymer or Oligomer)

The copolymerization ratio of the ethylenic unsaturated monomer having a cyano group in the molecule as the partial structure thereof to the other ethylenic unsaturated monomer is not specifically defined. The copolymerization ratio (by mol) is preferably (ethylenic unsaturated monomer having a cyano group in the molecule as the partial structure thereof)/(the other ethylenic unsaturated monomer) is from 5/95 to 100/0, more preferably from 50/50 to 100/0, even more preferably 100/0 (that is, the polymer or oligomer is a homopolymer of the ethylenic unsaturated monomer having a cyano group in the molecule as the partial structure thereof), from the viewpoint of reducing the photoelastic coefficient and the moisture content of the film of the invention.

### (Weight-Average Molecular Weight)

The weight-average molecular weight of the polymer or oligomer having a cyano group-containing recurring unit is preferably from 1000 to 100000, more preferably from 1000 to 50000, most preferably from 1000 to 10000.

### (Amount to be Added)

The content of the polymer or oligomer having a cyano group-containing recurring unit, relative to the cellulose acylate, is from 1.5 to 300% by mass, more preferably from 5 to 200% by mass, even more preferably from 10 to 150% by mass, still more preferably from 20 to 150% by mass, further more preferably from 50 to 150% by mass. In particular, the content is at most 300% by mass of the cellulose acylate from the viewpoint of the easiness in handling the film.

### <Cellulose Acylate>

Cellulose acylate is described in detail.

The starting material, cellulose for the cellulose acylate for the cellulose acylate film of the invention includes cotton linter and wood pulp (hardwood pulp, softwood pulp), etc. Any cellulose acylate obtained from any cellulose material is usable herein; and as the case may be, a mixture of different types of cellulose materials may be used here. Cellulose materials usable here are described in detail, for example, in Marusawa & Uda, “Plastic Material Lecture (17) Cellulose Resin” (published by Nikkan Kogyo Shinbun, 1970), and Hatsumei Kyokai Disclosure Bulletin No. 2001-1745 (pp. 7-8).

The cellulose acylate for use for the cellulose acylate film of the invention may have only one type of an acyl group, or two or more different types of acyl groups. Preferably, the cellulose acylate for use for the cellulose acylate film has an acyl group having from 2 to 4 carbon atoms as the substituent. In case where the cellulose acylate has two or more different types of acyl groups, preferably, one of them is an acetyl group. The acyl group having from 2 to 4 carbon atoms is preferably a propionyl group or a butyryl group. The cellulose acylate may form a solution of good solubility, and especially in a non-chlorine organic solvent, it may form a good solution. In particular, a solution having a low viscosity and good filterability can be produced.

Cellulose acylate preferred for use in the invention is described in detail. The β-1,4-bonding glucose unit to constitute cellulose has a free hydroxyl group at the 2-, 3- and 6-position. Cellulose acylate is a polymer prepared by acylating a part or all of these hydroxyl groups with acyl groups. The degree of acyl substitution means the total of the ratio of acylation of the hydroxyl groups in cellulose positioned in the 2-, 3- and 6-positions (the degree of 100% acyl acylation in each position is 1).

Preferably, the total degree of acyl substitution of the cellulose acylate is from 2.0 to 2.97, more preferably from 2.5 to less than 2.97, even more preferably from 2.70 to 2.95.

The acyl group having 2 or more carbon atoms in the cellulose acylate may be an aliphatic group or an aryl group with no specific limitation thereon. For example, it includes cellulose alkylcarbonyl esters, alkenylcarbonyl esters, aromatic carbonyl esters, aromatic alkylcarbonyl esters, etc., and these may have a substituent group. As their preferred examples, there may be mentioned an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an isobutanoyl group, a tert-butanoyl group, a cyclohexanecarbonyl group, an oleoyl group, a benzoyl group, a naphthylcarbonyl group, a cinnamoyl group, etc. Of those, preferred are an acetyl group, a propionyl group, a butanoyl group, a dodecanoyl group, an octadecanoyl group, a tert-butanoyl group, an oleoyl group, a benzoyl group, a naphthylcarbonyl group, a cinnamoyl group, etc.; more preferred are an acetyl group, a propionyl group and a butanoyl group (acyl groups each having from 2 to 4 carbon atoms); and even more preferred is an acetyl group (the cellulose acylate is cellulose acetate).

In case where an acid hydride or an acid chloride is used as the acylating agent for acylation of cellulose, the reaction solvent of an organic solvent to be used includes an organic acid, for example, acetic acid, methylene chloride, etc.

In case where the acylating agent is an acid anhydride, the catalyst to be used is preferably a protic catalyst such as sulfuric acid; and in case where the acylating agent is an acid chloride (for example, CH₃CH₂COCl), a basic compound is preferably used.

A most general method for industrial production of mixed fatty acid esters of cellulose comprises acylating cellulose with a mixed organic acid component containing a fatty acid corresponding to an acetyl group or any other acyl group (acetic acid, propionic acid, valeric acid, etc.), or an acid anhydride thereof.

The cellulose acylate can be produced, for example, according to the method described in JP-A 10-45804.

The cellulose acylate film preferably contains the cellulose acylate as the resin in an amount of from 5 to 99% by mass, from the viewpoint of the moisture permeability of the film, more preferably in an amount of from 20 to 99% by mass, even more preferably from 50 to 95% by mass.

### <Other Additives>

The cellulose acylate film may contain various additives of a polycondensation-type polymer, a retardation regulator (retardation enhancer, retardation reducer), a plasticizer such as a phthalate, a phosphate or the like, a UV absorbent, an antioxidant, a mat agent or the like, as the other additive than the polymer or oligomer having a cyano group-containing recurring unit.

### (Polycondensation-Type Polymer)

Preferably, the cellulose acylate film contains a polycondensation-type polymer from the viewpoint of reducing the haze thereof.

As the polycondensation-type polymer, herein widely usable is a high-molecular additive known as an additive to cellulose acylate films. The content of the additive is preferably from 1 to 35% by mass relative to the cellulose resin, more preferably from 4 to 30% by mass, even more preferably from 10 to 25% by mass.

The high-molecular additive that is used as the polycondensation-type polymer in the cellulose acylate film is a compound having a recurring unit therein, and is preferably one having a number-average molecular weight of from 700 to 10000. The high-molecular additive has the function of promoting the solvent evaporation speed in the solution casting method, and the function of reducing the residual solvent amount therein. Further, the additive exhibits various useful effects from the viewpoint of improving the properties of the film, for example, improving the mechanical properties of the film, imparting softness to the film, imparting water absorption resistance thereto, reducing the moisture permeability of the film, etc.

The number-average molecular weight of the high-polymer additive, or that is, the polycondensation-type polymer for use in the invention is more preferably from 700 to 8000, even more preferably from 700 to 5000, still more preferably from 1000 to 5000.

The polycondensation-type polymer, or that is, the high-molecular additive for use in the invention is described in detail hereinunder with reference to its specific examples given below. Needless-to-say, however, the high-molecular additive of the polycondensation-type polymer for use in the invention is not limited to those mentioned below.

Preferably, the polycondensation-type polymer is a non-phosphate-type ester compound. The “non-phosphate-type ester compound” means an ester compound not including phosphates.

The high-molecular additive of the polycondensation-type polymer includes polyester polymer (aliphatic polyester polymer, aromatic polyester polymer, etc.), and copolymer of polyester ingredient and other ingredient, etc. Preferred are aliphatic polyester polymer, aromatic polyester polymer; copolymer of polyester polymer (aliphatic polyester polymer, aromatic polyester polymer, etc.) and acrylic polymer; and copolymer of polyester polymer (aliphatic polyester polymer, aromatic polyester polymer, etc.) and styrenic polymer. More preferred are polyester compounds containing an aromatic ring as at least one copolymerization ingredient.

The aliphatic polyester polymer is obtained through reaction of an aliphatic dicarboxylic acid having from 2 to carbon atoms and at least one diol selected from an aliphatic diol having from 2 to 12 carbon atoms and an alkyl ether diol having from 4 to 20 carbon atoms; and both terminals of the reaction product may be as such directly after the reaction, but may be blocked through additional reaction with a monocarboxylic acid, a monoalcohol or a phenol. The terminal blocking is effective in point of the storability of the polymer, and is often attained for removing free carboxylic acids from the polymer. The dicarboxylic acid for use for the polyester polymer for use in the invention is preferably an aliphatic dicarboxylic acid residue having from 4 to 20 carbon atoms, or an aromatic dicarboxylic acid residue having from 8 to 20 carbon atoms.

The aliphatic dicarboxylic acid having from 2 to 20 carbon atoms preferred for use in the invention includes, for example, oxalic acid, malonic acid, succinic acid, maleic acid, fumaric acid, glutaric acid, adipic acid, pimelic acid, suberic acid, azelaic acid, sebacic acid, dodecanedicarboxylic acid, and 1,4-cyclohexanedicarboxylic acid.

Of those, preferred aliphatic dicarboxylic acids are malonic acid, succinic acid, maleic acid, fumaric acid, glutaric acid, adipic acid, azelaic acid and 1,4-cyclohexanedicarboxylic acid. More preferred aliphatic dicarboxylic acids are succinic acid, glutaric acid and adipic acid.

The diol for use for the high-molecular additive is, for example, selected from an aliphatic diol having from 2 to 20 carbon atoms, and an alkyl ether diol having from 4 to 20 carbon atoms.

The aliphatic diol having from 2 to 20 carbon atoms includes an alkyl diol and alicyclic diol, for example, ethanediol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol, 1,12-octadecanediol, etc. One or more of these glycols may be used here either singly or as combined in a mixture thereof.

Preferred diols are ethanediol, 1,2-propanediol, 1,3-propanediol, 1,2-butanediol, 1,3-butanediol, 2-methyl-1,3-propanediol, 1,4-butanediol, 1,5-pentanediol, 3-methyl-1,5-pentanediol, 1,6-hexanediol, 1,4-cyclohexanediol, and 1,4-cyclohexanedimethanol; and more preferred are ethanediol, 1,2-propanediol, 1,3-propanediol, 1,2-butanediol, 1,3-butanediol, 1,4-butanediol, 1,5-pentanediol, 1,6-hexanediol, 1,4-cyclohexanediol, and 1,4-cyclohexanedimethanol.

AS the alkyl ether diol having from 4 to 20 carbon atoms, preferably mentioned are polytetramethylene ether glycol, polyethylene ether glycol and polypropylene ether glycol, and their mixtures. Not specifically defined, the mean degree of polymerization of the diol is from 2 to 20, more preferably from 2 to 10, even more preferably from 2 to 5, still more preferably from 2 to 4. As their examples, typically mentioned are commercially-available polyether glycols, Carbowax Resin, Pluronics Resin and Niax Resin.

In the invention, especially preferred is use of a high-molecular additive of which the terminals are blocked with an alkyl group or an aromatic group. In these, since the terminals are protected with a hydrophobic functional group, and therefore, the additive is effective against deterioration with time in high-temperature and high-humidity environments. This is because the hydrolysis of the ester group in these is retarded.

In the invention, preferably, both terminals of the polyester additive are protected with a monoalcohol residue or a monocarboxylic acid residue so that the terminals could not be a carboxylic acid or an OH group.

In this case, as the monoalcohol, preferred is a substituted or unsubstituted monoalcohol having from 1 to carbon atoms, and there may be mentioned aliphatic alcohols such as methanol, ethanol, propanol, isopropanol, butanol, isobutanol, pentanol, isopentanol, hexanol, isohexanol, cyclohexyl alcohol, octanol, isooctanol, 2-ethylhexyl alcohol, nonyl alcohol, isononyl alcohol, tert-nonyl alcohol, decanol, dodecanol, dodecahexanol, dodecaoctanol, allyl alcohol, oleyl alcohol, etc.; and substituted alcohols such as benzyl alcohol, 3-phenylpropanol, etc.

Alcohols preferred for use for terminal blocking include methanol, ethanol, propanol, isopropanol, butanol, isobutanol, isopentanol, hexanol, isohexanol, cyclohexyl alcohol, isooctanol, 2-ethylhexyl alcohol, isononyl alcohol, oleyl alcohol, benzyl alcohol; and more preferred are methanol, ethanol, propanol, isobutanol, cyclohexyl alcohol, 2-ethylhexyl alcohol, isononyl alcohol, benzyl alcohol.

In case where the terminals are blocked with a monocarboxylic acid residue, the monocarboxylic acid for the monocarboxylic acid residue is preferably a substituted or unsubstituted monocarboxylic acid having from 1 to 30 carbon atoms. The acid may be an aliphatic monocarboxylic acid or an aromatic ring-containing carboxylic acid. As preferred aliphatic monocarboxylic acids, there may be mentioned acetic acid, propionic acid, butanoic acid, caprylic acid, caproic acid, decanoic acid, dodecanoic acid, stearic acid, oleic acid; and as aromatic ring-containing monocarboxylic acids, for example, there may be mentioned benzoic acid, p-tert-butylbenzoic acid, p-tert-amylbenzoic acid, ortho-toluic acid, meta-toluic acid, para-toluic acid, dimethylbenzoic acid, ethylbenzoic acid, normal propylbenzoic acid, aminobenzoic acid, acetoxybenzoic acid, etc. One or more of these may be used here.

The high-molecular additive may be produced with ease according to ordinary methods, for example, according to a thermal melt condensation method of polyesterification reaction or interesterification reaction of the above-mentioned aliphatic dicarboxylic acid and diol and/or the monocarboxylic acid or monoalcohol for terminal blocking, or according to a method of interfacial condensation of a chloride of such an acid and a glycol. The polyester additives are described in detail by Koichi Murai in “Additives, Their Theory and Application” (by Miyuki Publishing, 1st edition of original version published on Mar. 1, 1973). Materials described in JP-A 05-155809, 05-155810, 05-197073, 2006-259494, 07-330670, 2006-342227, 2007-003679 are also usable herein.

The aromatic polyester polymer can be produced through copolymerization of the above-mentioned polyester polymer with an aromatic ring-having monomer. The aromatic ring-having monomer is at least one monomer selected from aromatic dicarboxylic acids having from 8 to 20 carbon atoms, and aromatic diols having from 6 to 20 carbon atoms.

The aromatic dicarboxylic acid having from 8 to 20 carbon atoms includes phthalic acid, terephthalic acid, isophthalic acid, 1,5-naphthalenedicarboxylic acid, 1,4-naphthalenedicarboxylic acid, 1,8-naphthalenedicarboxylic acid, 2,8-naphthalenedicarboxylic acid, and 2,6-naphthalenedicarboxylic acid. Of those, preferred aromatic dicarboxylic acids are phthalic acid, terephthalic acid, and isophthalic acid.

The aromatic diol having from 6 to 20 carbon atoms includes, though not specifically defined, bisphenol A, 1,2-hydroxybenzene, 1,3-hydroxybenzene, 1,4-hydroxybenzene, 1,4-benzenedimethanol. Preferred are bisphenol A, 1,4-hydroxybenzene and 1,4-benzenedimethanol.

In the invention, the aromatic polyester polymer is used as a combination of the above-mentioned polyester with at least one of an aromatic dicarboxylic acid or an aromatic diol, and the combination is not specifically defined. Several types of the respective ingredients may be combined in any desired manner. In the invention, as described above, the high-molecular additive is blocked with an alkyl group or an aromatic group at the terminals thereof, and for blocking the terminals, the above-mentioned method is employable.

### (Retardation Reducer)

As the retardation reducer in the invention, widely employable are phosphate compounds and compounds except non-phosphate compounds known as additives to cellulose acylate film.

The polymer-type retardation reducer usable herein is selected from phosphate-type polyester polymers, styrenic polymers, acrylic polymers and their copolymers; and preferred are acrylic polymers and styrenic polymers. Preferably, the film in the invention contains at least one polymer having an inherent negative birefringence, such as styrenic polymers and acrylic polymers.

The low-molecular retardation reducer that is a compound except non-phosphate compounds includes the following. These may be solid or oily. Briefly, the melting point and the boiling point of the compounds are not specifically defined. For example, there may be mentioned a mixture of UV absorbent materials in which the melting or boiling point of one material is not higher than 20° C. and that of the other is higher than 20° C., and a mixture of degradation inhibitors of the same type as above. IR absorbent dyes usable herein are described, for example, in JP-A 2001-194522. The time when the additive is added may be at any time in the cellulose acylate solution (dope) production step. As the case may be, a step of adding the additive may be additionally provided in the final stage after the dope preparation step. The amount of the material to be added is not specifically defined so far as the material can express its function.

The low-molecular retardation reducer that is a compound except non-phosphate compounds is not specifically defined, and its details are described in JP-A 2007-272177, [0066] to [0085].

The compounds represented by the formula (1) in JP-A 2007-272177, [0066] to [0085] can be produced according to the following method.

The compound of the formula (1) in the patent publication can be produced through condensation of a sulfonyl chloride derivative and an amine derivative.

The compound represented by the genera formula (2) in JP-A 2007-272177 can be produced through dehydrating condensation of a carboxylic acid and an amine using a condensing agent (for example, dicyclohexylcarbodiimide (DCC), etc.), or through substitution reaction of a carboxylic acid chloride derivative and an amine derivative.

The retardation reducer is preferably an Rth reducer from the viewpoint of realizing a favorable Nz factor. The Rth reducer of the retardation reducer includes acrylic polymers and styrenic polymers as well as low-molecular compounds of the formulae (3) to (7) in the above-mentioned patent publication. Of those, preferred are acrylic polymers and styrenic polymers, and more preferred are acrylic polymers.

Preferably, the retardation reducer is added in a ratio of from 0.01 to 30% by mass relative to the cellulose resin, more preferably from 0.1 to 20% by mass, even more preferably from 0.1 to 10% by mass.

When the amount is at most 30% by mass, the compatibility of the compound with the cellulose resin can be bettered, and the formed film can be prevented from whitening. In case where two or more different types of retardation reducers are used, preferably, their total amount is within the above range.

### (Retardation Enhancer)

Preferably, the cellulose acylate film contains at least one retardation enhancer in the above-mentioned low-substitution layer for the purpose of expressing the retardation value thereof. The retardation enhancer is not specifically defined. There may be mentioned rod-shaped or discotic compounds, as well as those of the above-mentioned non-phosphate compounds that have a retardation enhancing capability. As the rod-shaped or discotic compounds, compounds having at least two aromatic rings are preferably used herein as the retardation enhancer.

The amount to be added of the retardation enhancer of a rod-shaped compound is preferably from 0.1 to 30 parts by mass relative to 100 parts by mass of the polymer ingredient containing cellulose acylate, more preferably from 0.5 to 20 parts by mass. Preferably, the amount of the discotic compound contained in the retardation enhancer is less than 3 parts by mass relative to 100 parts by mass of the cellulose acylate, more preferably less than 2 parts by mass, even more preferably less than 1 part by mass.

Discotic compounds are superior to rod-shaped compounds in point of the Rth retardation enhancing capability thereof, and therefore the former is favorably used when an especially large Rth retardation is needed. Two or more different types of retardation enhancers may be used here as combined.

Preferably, the retardation enhancer for use herein has a maximum absorption in a wavelength region of from 250 to 400 nm, but does not have any substantial absorption in the visible region.

The details of the retardation enhancer are described in Disclosure Bulletin 2001-1745, p. 49.

### (Plasticizer)

As the plasticizer in the invention, many compounds known as a plasticizer for cellulose acylate are usable.

For example, the plasticizer includes phosphates or carboxylates. Examples of the phosphates are triphenyl phosphate (TPP) and tricresyl phosphate (TCP). The carboxylates are typically phthalates and citrates. Examples of the phthalates are dimethyl phthalate (DMP, diethyl phthalate (DEP), dibutyl phthalate (DBP), dioctyl phthalate (DOP), diphenyl phthalate (DPP) and diethylhexyl phthalate (DEHP). Examples of the citrates are triethyl O-acetylcitrate (OACTE) and tributyl O-acetylcitrate (OACTB). Examples of the other carboxylates are butyl oleate, methylacetyl ricinoleate, dibutyl sebacate, and various types of trimellitates. Preferred is use of the phthalate plasticizer (DMP, DEP, DBP, DOP, DPP, DEHP). More preferred are DEP and DPP.

### (Antioxidant)

In the invention, a known antioxidant, for example, a phenolic or hydroquinone-type antioxidant such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone, pentaerythrityl tetrakis[3-(3,5-di-tert-butyl-4-hydroxyphenyl)propionate] or the like may be added to the cellulose acylate solution. Further, preferred is use of a phosphate-type antioxidant such as tris(4-methoxy-3,5-diphenyl) phosphite, tris(nonylphenyl) phosphite, tris(2,4-di-tert-butylphenyl) phosphite, bis(2,6-di-tert-butyl-4-methylphenyl)pentaerythritol diphosphite, bis(2,4-di-tert-butylphenyl)pentaerythritol diphosphite, etc.

Preferably, the amount of the antioxidant to be added is from 0.05 to 5.0 parts by mass relative to 100 parts by mass of the cellulose resin.

### (UV Absorbent)

In the invention, a UV absorbent may be added to the cellulose acylate solution from the viewpoint of preventing the degradation of polarizer, liquid crystal, etc. As the UV absorbent, preferred are those excellent in UV absorbability at a wavelength of at most 370 nm and poorly absorbing visible light having a wavelength of 400 nm or more, from the viewpoint of securing good liquid-crystal display performance. Specific examples of the UV absorbent preferred for use in the invention include, for example, hindered phenolic compounds, hydroxybenzophenone compounds, benzotriazole compounds, salicylate compounds, benzophenone compounds, cyanoacrylate compounds, nickel complex compounds, etc. Examples of the hindered phenolic compounds include 2,6-di-tert-butyl-p-cresol, pentaerythrityl tetrakis[3-(3,5-di-tert-butyl-4-hydroxyphenyl) propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, tris-(3,5-di-tert-butyl-4-hydroxybenzyl) isocyanurate, etc. Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, (2-(2′-hydroxy-3′,5′-di-tert-amylphenyl)-5-chlorobenzotriazole, 2,6-di-tert-butyl-p-cresol, pentaerythrityl tetrakis[3-(3,5-di-tert-butyl-4-hydroxyphenyl)propionate], etc. The amount of the UV inhibitor is preferably from 1 ppm to 1.0% by mass in the entire optical film, more preferably from 10 to 1000 ppm.

### (Mat Agent)

A mat agent may be added to the cellulose acylate film from the viewpoint of securing film slidability and securing safe production. The mat agent may be an inorganic compound mat agent or an organic compound mat agent.

Preferred examples of the inorganic compound mat agent are silicon-containing inorganic compounds (e.g., silicon dioxide, fired calcium silicate, hydrated calcium silicate, aluminium silicate, magnesium silicate, etc.), titanium oxide, zinc oxide, aluminium oxide, barium oxide, zirconium oxide, strontium oxide, antimony oxide, tin oxide, tin antimony oxide, calcium carbonate, talc, clay, fired kaolin, calcium phosphate, etc. More preferred are silicon-containing inorganic compounds and zirconium oxide; and even more preferred is use of silicon dioxide as capable of reducing the haze of the cellulose acylate film. As fine particles of silicon dioxide, usable are commercially-available products of, for example, trade names of Aerosil R972, R974, R812, 200, 300, R202, OX50, TT600 (all by Nippon Aerosil), etc. As fine particles of zirconium oxide, usable are commercial products of, for example, trade names of Aerosil R976 and R811 (both by Nippon Aerosil), etc.

Preferred examples of the organic compound mat agent include, for example, polymers such as silicone resin, fluororesin, acrylic resin, etc., and more preferred is silicon resin. Of silicon resin, especially preferred are those having a three-dimensional network structure, for which, for example, usable are commercially-available products of Tospearl 103, Tospearl 105, Tospearl 108, Tospearl 120, Tospearl 145, Tospearl 3120 and Tospearl 240 (all by Toshiba Silicone), etc.

In case where the mat agent is added to the cellulose acylate solution, the method is not specifically defined, and any method capable of producing the desired cellulose acylate solution is employable with no problem. For example, the additive may be added in the stage where cellulose acylate is mixed with solvent, or the additive may be added after a mixed solution of cellulose acylate and solvent has been prepared. Further, the additive may be added and mixed just before the dope is cast, and this is a method of addition just before casting, in which a screw-type kneading mixer may be provided for on-line mixing. Concretely, a static mixer such as an in-line mixer is preferred. As the in-line mixer, for example, preferred is a static mixer, or a static-type in-line mixer High-Mixer SWJ (by Toray Engineering). Regarding in-line addition, JP-A 2003-053752 describes an invention of a production method for a cellulose acylate film, in which the distance (L) between the tip of the supply nozzle where an additive liquid having a different composition is added to the main material dope and the starting side of the in-line mixer is controlled to be at most 5 times the inner diameter d of pipeline for the main material, whereby the density unevenness and the mat particles aggregation can be removed. The patent publication describes a more preferred embodiment of the invention where the distance (L) between the tip of the supply nozzle where an additive liquid having a different composition is added to the main material dope and the starting side of the in-line mixer is controlled to be at most 10 times the inner diameter (d) of the opening of the tip of the supply nozzle, and the in-line mixer is a static non-stirring in-line mixer or a dynamic stirring in-line mixer. More concretely, as illustrated in the patent publication, the flow rate of the cellulose acylate film main material dope/in-line additive liquid is from 10/1 to 500/1, preferably from 50/1 to 200/1. Further, JP-A 2003-014933 which provides an invention of a retardation film free from a problem of delamination of the constitutive layers, having good lubricity and excellent in transparency, discloses a method of adding an additive to the film. According to the method, the additive may be added to the melting tank, or the additive or a solution or dispersion of the additive may be added to the dope being fed from the melting tank to the co-casting die, and the patent publication says that, in the latter method, a static mixer or the like mixing means is preferably provided for the purpose of enhancing the mixing performance.

Unless the mat agent is added too much to the cellulose acylate film, the haze of the film does not increase; and in fact, in a case where the film is used in LCD, the mat agent added thereto does not cause any inconveniences of contrast reduction, bright spot generation, etc. On the other hand, when the amount is too small, then the problem of film grating could not be solved and the abrasion resistance of the film could not be realized. From these viewpoints, preferably, the mat agent is added in a ratio of from 0.05 to 1.0% by weight.

### <Configuration and Physical Properties of Cellulose Acylate Film>

### (Layer Configuration of Film)

The cellulose acylate film may be a single layer or a laminate of two or more layers.

In case where the cellulose acylate film is a two-layer or more multi-layer laminate, it is preferably a two-layer laminate or a three-layer laminate, more preferably a three-layer laminate. Preferably, the three-layer laminate has a layer of the film of the invention that is kept in contact with the metal support in producing the film according to a solution casting method (hereinafter this may be referred to as a support-side layer or a skin B layer), and an air interface layer opposite to the metal support (hereinafter this may be referred to as an air-side layer or a skin A layer), and one core layer sandwiched between them. Specifically, the film of the invention has a three-layer configuration of skin B layer/core layer/skin A layer.

Collectively the skin layer A and the skin layer B may be called a skin layer (or a surface layer).

In the cellulose acylate film, the degree of acyl substitution of the cellulose acylate of each layer may be the same, or a plurality of cellulose acylates may be made to form one layer as mixed. In the latter case, preferably, the degree of acyl substitution of the cellulose acylate in every layer is all the same from the viewpoint of controlling the optical properties of the film. In case where the cellulose acylate film has a three-layer configuration, preferably, the cellulose acylate contained in both surface layers of the film has the same degree of acyl substitution from the viewpoint of the production cost of the film.

### (Photoelastic Coefficient)

Preferably, the absolute value of the photoelastic coefficient of the resin film of the invention is at most 10×10⁻¹² m²/N, more preferably at most 7×10⁻¹² m²/N, even more preferably at most 5×10⁻¹² m²/N. Reducing the photoelastic coefficient of the resin film makes it possible to prevent generation of unevenness in high-temperature high-humidity environments when the resin film is incorporated in a liquid-crystal display device as the polarizer protective film therein.

The photoelastic coefficient can be determined as follows: The film is cut into a size of 3.5 cm×12 cm, and given a tensile stress applied thereto in the lengthwise direction of the film, whereupon the retardation change at a wavelength of 632.8 nm is divided by the stress change to thereby determine the photoelastic coefficient of the film.

### (Moisture Content)

The moisture content of the resin film can be determined by measuring the equilibrium moisture content thereof at a predetermined temperature and humidity. The equilibrium moisture content can be determined as follows: After the film has been left at a predetermined temperature and humidity for 24 hours, the amount of moisture in the thus-equilibrated sample is measured according to a Karl-Fischer method, and the amount of moisture (g) is divided by the sample weight (g) to give the moisture content of the film.

Preferably, the moisture content of the resin film at 25° C. and at a relative humidity of 80% is at most 5% by mass, more preferably at most 4% by mass, even more preferably at most 3% by mass. Reducing the moisture content of the resin film makes it possible to prevent generation of unevenness in high-temperature high-humidity environments when the resin film is incorporated in a liquid-crystal display device as the polarizer protective film therein.

### (Haze)

Preferably, the haze of the cellulose acylate film is at most 1%, more preferably at most 0.7%, even more preferably at most 0.5%. When the haze is at most 1%, the film transparency could be higher, which brings about an advantage in that the film is more suitable for use as an optical film.

### (Film Thickness)

Of the cellulose acylate film, the mean thickness of the low-substitution layer is preferably from 30 to 100 μm, more preferably from 30 to 80 μm, even more preferably from 30 to 70 μm. When the thickness is at least 30 μm, then it is favorable since the handlability in producing a web-like film is bettered. When the thickness is at most 70 μm, the film is resistant to humidity change and can secure the optical properties thereof.

In case where the cellulose acylate film has a three-layer or more multi-layer laminate structure, the thickness of the core layer is preferably from 30 to 70 μm, more preferably from 30 to 60 μm. In case where the film of the invention has a three-layer or more multi-layer laminate structure, the thickness of the two surface layers (skin layer A and skin layer B) on both sides of the film is from 0.5 to 20 μm each, more preferably from 0.5 to 10 μm each, even more preferably from 0.5 to 3 μm each.

### (Film Width)

Preferably, the cellulose acylate film has a width of from 700 to 3000 mm, more preferably from 1000 to 2800 mm, even more preferably from 1300 to 2500 mm.

### <Production Method for Cellulose Acylate Film>

The production method for the cellulose acylate film for use in the invention is described in detail hereinunder.

Preferably, the cellulose acylate film is produced according to a solvent casting method. For production examples of cellulose acylate film according to a solvent casting method, referred to are U.S. Pat. Nos. 2,336,310, 2,367,603, 2,492,078, 2,492,977, 2,492,978, 2,607,704, 2,739,069, 2,739,070; British Patent 640731, 736892; JP-B 45-4554, 49-5614; JP-A 60-176834, 60-203430, 62-115035, etc. The cellulose acylate film may be stretched. For the method of stretching treatment and the condition thereof, referred to are, for example, JP-A 62-115035, 4-152125, 4-284211, 4-298310, 11-48271, etc.

### (Casting Method)

The solution casting method includes a method of extruding a prepared dope uniformly onto a metal support through a pressure die; a doctor blade method in which the dope once cast onto a metal support is leveled with a blade to control the thickness of the formed film; a method of using a reverse roll coater in which the film thickness is controlled by the reversely-rotating roll, etc. Preferred is the method of using a pressure die. The pressure die includes a coat-hanger type die, a T-die, etc., any of which is favorably usable here. Apart from the methods described herein, any other various types of known methods for producing films by casting cellulose triacetate solution are employable here. In consideration of the difference in the boiling point of the solvents used, the casting condition may be settled, and the same effects as those described in the related patent publications can also be obtained here.

### <<Co-Casting>>

In producing the cellulose acylate film, preferably used is a lamination casting method such as a co-casting method, a successive casting method, a coating method, etc. More preferred is a simultaneous co-casting method from the viewpoint of stable production and production cost reduction.

In case where the film is produced according to a co-casting method or a successive casting method, first prepared is the cellulose acetate solution (dope) for each layer. In the co-casting method (multilayer simultaneous casting method), co-casting dopes are simultaneously extruded out through a casting Giesser through which the individual casting dopes for the intended layers (the layers may be three or more layers) are simultaneously cast via different slits onto a casting support (band or drum), and at a suitable time, the film formed on the metal support is peeled away and dried. FIG. 2 is a cross-sectional view showing a mode of simultaneous extrusion to form three layers by casting the dope 1 for surface layer and the dope 2 for core layer on a casting support 4 through a co-casting Giesser 3.

The successive-casting method is as follows: First the dope for the first layer is extruded out and cast onto a casting support through a casting Giesser, then after it is dried or not dried, the casting dope for the second layer is cast onto it in a mode of extrusion through a casting Giesser, and if desired, three or more layers are successively formed in the same mode of casting and lamination, and at a suitable time, the resulting laminate film is peeled away from the support and dried. The coating method is generally as follows: A film of a core layer is formed according to a solution casting method, then a coating solution for surface layer is prepared, and using a suitable coater, the coating solution is applied onto the previously formed core film first on one surface thereof and next on the other surface thereof, or simultaneously on both surfaces thereof, and the resulting laminate film is dried.

As the endlessly running metal support for use in producing the cellulose acylate film, usable is a drum of which the surface is mirror-finished by chromium plating, or a stainless belt (band) of which the surface is mirror-finished by polishing. One or more pressure dies may be arranged above the metal support. Preferably, one or two pressure dies are arranged. In case where two or more pressure dies are arranged, the dope to be cast may be divided into portions suitable for the individual dies; or the dope may be fed to the die at a suitable proportion via a plurality of precision metering gear pumps. The temperature of the dope (resin solution) to be cast is preferably from −10 to 55° C., more preferably from 25 to 50° C. In this case, the solution temperature may be the same throughout the entire process, or may differ in different sites of the process. In case where the temperature differs in different sites, the dope shall have the desired temperature just before cast.

The material of the metal support is not specifically defined. Preferably, the metal support is formed of SUS (for example, SUS 316).

### (Peeling)

The production method for the cellulose acylate film preferably includes a step of peeling the dope film from the metal support. The peeling method in the cellulose acylate film production method is not specifically defined. Any known method is employable here for enhancing the peelability of the film.

### (Stretching Treatment)

The method for producing the cellulose acylate film preferably includes a step of stretching the formed film. The stretching direction of the cellulose acylate film may be preferably any of the film traveling direction or the direction perpendicular to the film traveling direction (cross direction). More preferably, the film is stretched in the direction perpendicular to the film traveling direction (cross direction) from the viewpoint of the subsequent process of using the film for producing a polarizer.

The method of stretching in the cross direction is described, for example, in JP-A 62-115035, 4-152125, 4-284211, 4-298310, 11-48271, etc. For the machine-direction stretching, for example, the speed of the film conveyor rollers is regulated so that the film winding speed could be higher than the film peeling speed whereby the film may be stretched. For the cross-direction stretching, the film is conveyed while held by a tenter on the sides thereof and the tenter width is gradually broadened, whereby the film can be stretched. After dried, the film may be stretched with a stretcher (preferably for monoaxial stretching with a long stretcher).

In case where the cellulose acylate film is used as a protective film for a polarizing element, the transmission axis of the polarizing element must be in parallel to the in-plane slow axis of the resin film of the invention so as to prevent the light leakage in oblique directions to the polarizer. The transmission axis of the roll film-type polarizing element that is produced continuously is generally parallel to the cross direction of the roll film, and therefore, in continuously sticking the roll film-type polarizing element and a protective film comprising the roll film-type cellulose acylate film, the in-plane slow axis of the roll film-type protective film must be parallel to the cross direction of the film. Accordingly, the film is preferably stretched to a larger extent in the cross direction. The stretching treatment may be attained during the course of the film formation process, or the wound film may be unwound and stretched.

The draw ratio in stretching in the cross direction is preferably from 5 to 100%, more preferably from 5 to 80%, even more preferably from 5 to 40%. The stretching treatment may be attained during the course of the film formation process, or the wound film may be unwound and stretched. In former case, the film may be stretched while it contains the residual solvent therein. Preferably, the film may be stretched, having a residual solvent content=(mass of residual volatile/mass of film after heat treatment)×100%, of from 0.05 to 50%. More preferably, the film is stretched while having a residual content of from 0.05 to 5% in a draw ratio of from 5 to 80%.

### (Drying)

Preferably, the production method for the cellulose acylate film includes a step of drying the cellulose acylate laminate film and a step of stretching the dried resin film of the invention at a temperature not lower than (Tg−10° C.), from the viewpoint of enhancing the retardation of the film.

For drying the dope on a metal support in production of the cellulose acylate film, generally employable is a method of applying hot air to the surface of the metal support (drum or belt), or that is, onto the surface of the web on the metal support; a method of applying hot air to the back of the drum or belt; or a back side liquid heat transfer method that comprises contacting a temperature-controlled liquid with the opposite side of the dope-cast surface of the belt or drum, or that is, the back of the belt or drum to thereby heat the belt or drum by heat transmission to control the surface temperature thereof. Preferred is the backside liquid heat transfer method. Preferred is the back side liquid heat transfer method. The surface temperature of the metal support before the dope is cast thereon may be any degree so far as it is not higher than the boiling point of the solvent used in the dope. However, for promoting the drying or for making the dope lose its flowability on the metal support, preferably, the temperature is set to be lower by from 1 to 10° C. than the boiling point of the solvent having the lowest boiling point of all the solvents in the dope. In case where the cast dope is peeled off after cooled but not dried, then this shall not apply to the case.

For controlling the thickness of the film, the solid concentration in the dope, the slit gap of the die nozzle, the extrusion pressure from the die, and the metal support speed may be suitably regulated so that the formed film could have a desired thickness.

Produced in the manner as above, the length of the cellulose acylate film to be wound up is preferably from 100 to 10000 m per roll, more preferably from 500 to 7000 m, even more preferably from 1000 to 6000 m. In winding the film, preferably, at least one side thereof is knurled, and the knurling width is preferably from 3 mm to 50 mm, more preferably from 5 mm to 30 mm, and the knurling height is preferably from 0.5 to 500 μm, more preferably from 1 to 200 μm. This may be one-way or double-way knurling.

In general, in large-panel display devices, contrast reduction and color shift may be remarkable in oblique directions; and therefore the cellulose acylate film is especially suitable for use in large-panel display devices. In case where the film of the invention is used as an optical compensatory film for large-panel liquid-crystal display devices, for example, the film is shaped to have a width of at least 1470 mm. The polarizer protective film of the invention includes not only film sheets cut to have a size that may be directly incorporated in liquid-crystal display devices but also long films continuously produced and rolled up into rolls. The polarizer protective film of the latter embodiment is stored and transported in the rolled form, and is cut into a desired size when it is actually incorporated into a liquid-crystal display device or when it is stuck to a polarizing element or the like. The long film may be stuck to a polarizing element formed of a long polyvinyl alcohol film directly as they are long, and then when this is actually incorporated into a liquid-crystal display device, it may be cut into a desired size. One embodiment of the long optical compensatory film rolled up into a roll may have a length of 2500 m/roll or more.

### [Polarizer]

The invention also relates to a polarizer comprising at least one polarizer protective film of the invention.

Preferably, the polarizer of the invention comprises a polarizing element and the film of the invention on one face of the polarizing element. Like that of the optical compensatory film of the invention, the embodiment of the polarizer of the invention may include not only polarizers in the form of film sheets cut to have a size that may be directly incorporated in liquid-crystal display devices but also polarizers in the form of long films continuously produced and rolled up into rolls (for example having a length of at least 2500 m/roll or at least 3900 m/roll). For use in large-panel liquid-crystal display devices, the width of the polarizer is preferably at least 1470 mm as so mentioned in the above.

The concrete constitution of the polarizer of the invention is not specifically defined, for which, therefore, any known constitution is employable. For example, the constitution of FIG. 6 in JP-A 2008-262161 is employable here.

### [Liquid-Crystal Display Device]

The invention also relates to a liquid-crystal display device comprising the polarizer protective film of the invention or the polarizer of the invention.

The liquid-crystal display device of the invention is a liquid-crystal display device, preferably an IPS, OCB or VA-mode liquid-crystal display device comprising a liquid-crystal cell and a pair of polarizers arranged on both sides of the liquid-crystal cell, in which at least one of the polarizers is the polarizer of the invention.

The concrete constitution of the liquid-crystal display device of the invention is not specifically defined, for which, therefore, any known constitution is employable. The constitution of FIG. 2 in JP-A 2008-262161 is also preferably employable herein.

### EXAMPLES

The invention is described more concretely with reference to the following Examples. In the following Examples, the materials, the reagents and the substances used, their amount and ratio, the details of the treatment and the treatment process may be suitably modified or changed not overstepping the sprit and the scope of the invention. Accordingly, the invention should not be limitatively interpreted by the Examples mentioned below.

### Example 101

### (1) Formation of Cellulose Acylate Film

### <Preparation of Cellulose Acylate>

Cellulose acylate having a degree of acetyl substitution of 2.87 was prepared. As a catalyst, sulfuric acid (7.8 parts by mass relative to 100 parts by mass of cellulose) was added to cellulose, and a carboxylic acid to be the starting material for the acyl substituent was added thereto for acylation at 40° C. After the acylation, the system was ripened at 40° C. Further, the cellulose acylate was washed with acetone to remove the low-molecular fraction therefrom.

### <Preparation of Surface Layer Dope 101>

### (Preparation of Cellulose Acylate Solution)

The following composition was put into a mixing tank and stirred to dissolve the ingredients, thereby preparing a cellulose acylate solution 1.

Composition of Cellulose Acylate Solution 1

| | |
|---|---|
| Cellulose acetate having a degree of acetyl substitution | 100.0 mas. pts. |
| of 2.87 and a degree of polymerization of 370 | |
| Triphenyl phosphate | 8.0 mas. pts. |
| Phenylbiphenyl phosphate | 4.0 mas. pts. |
| Methylene chloride (first solvent) | 353.9 mas. pts. |
| Methanol (second solvent) | 89.6 mas. pts. |
| N-butanol (third solvent) | 4.5 mas. pts. |

### (Preparation of Mat Agent Solution 2)

The following composition was put into a mixing tank and stirred to dissolve the ingredients, thereby preparing a mat agent solution 2.

Composition of Mat Agent Solution 2

| | |
|---|---|
| Silica particles having a mean particle size of 20 | 2.0 mas. pts. |
| nm (AEROSIL R972, by Nippon Aerosil) | |
| Methylene chloride (first solvent) | 69.3 mas. pts. |
| Methanol (second solvent) | 17.5 mas. pts. |
| N-butanol (third solvent) | 0.9 mas. pts. |
| Cellulose acylate solution 1 | |

### (Preparation of UV Absorbent Solution 3)

The following composition was put into a mixing tank and stirred under heat to dissolve the ingredients, thereby preparing a UV absorbent solution 3.

Composition of UV Absorbent Solution 3

| | | |
|---|---|---|
| UV absorbent C mentioned below | 20.0 | mas.pts. |
| Methylene chloride (first solvent) | 61.0 | mas.pts. |
| Methanol (second solvent) | 15.4 | mas.pts. |
| N-butanol (third solvent) | 0.8 | mas.pts. |
| Celulose acylate solution 1 mentioned | 12.8 | mas.pts. |
| above | | |

UV Absorbent C

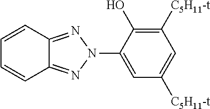

1.3 parts by mass of the mat agent solution 2 and 3.4 parts by mass of the UV absorbent solution 3 were, both after filtered separately, mixed using an in-line mixer, and 95.3 parts by mass of the cellulose acylate solution 1 was added thereto and further mixed with the in-line mixer to prepare a surface layer solution 101.

### <Preparation of Substrate Layer Dope 101>

### (Preparation of Cellulose Acylate Solution)

The following composition was put into a mixing tank and stirred to dissolve the ingredients, thereby preparing a substrate layer dope.

Composition of Cellulose Acylate Solution 2

| | |
|---|---|
| Cellulose acetate having a degree of acetyl substitution | 100.0 mas. pts. |
| of 2.87 and a degree of polymerization of 370 | |
| Homopolymer of ethylenic unsaturated monomer A | 43.0 mas. pts. |
| UV absorbent C | 2.0 mas. pts. |
| Methylene chloride (first solvent) | 297.7 mas. pts. |
| Methanol (second solvent) | 75.4 mas. pts. |
| N-butanol (third solvent) | 3.8 mas. pts. |

### <Casting>

Using a drum casting apparatus, three layers of the previously-prepared dope (substrate layer dope) and the surface layer dope to be on both sides of the substrate layer dope were simultaneously cast onto a stainless casting support (support temperature, −9° C.), each uniformly via the casting mouth thereonto. The film was peeled away while the residual solvent amount in the dope of each layer was about 70% by mass; and both sides of the film in the cross direction were fixed with a pin tenter, and while the residual solvent amount therein was from 3 to 5% by mass, the film was dried with stretching it by 1.28 times in the cross direction. Subsequently, the film was conveyed between the rolls in a heat treatment unit and was further dried therein, thereby giving a cellulose acylate film of Example 101. The thickness of the thus-obtained cellulose acylate film was 60 μm, and the width thereof was 1480 mm.

### Examples 102 to 112 and Comparative Examples 201 to 207

### Production of Polarizer Protective Films of Examples 102 to 112 and Comparative Examples 201 to 207

Polarizer films of Examples 102 to 112 and Comparative Examples 201 to 207 were produced in the same manner as in Example 1 except that the type and the amount of the ethylenic unsaturated polymer were changed as in Table 1.

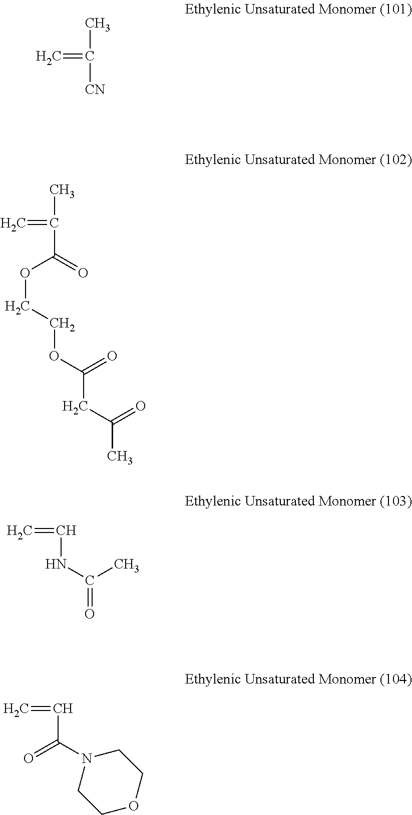

### [Evaluation]

### (Determination of Photoelastic Coefficient)

The film was cut into a size of 3.5 cm×12 cm, and Re thereof was measured under no load, or under a load of 250 g, 500 g, 1000 g or 1500 g, using a ellipsometer (M150, by JASCO), and from the inclination of the linear line indicating the Re change to the stress, the photoelastic coefficient of the film was computed.

### (Measurement of Moisture Content)

The film was conditioned in an environment at 25° C. and at a relative humidity of 80% for 24 hours, and the equilibrium water content thereof was measured, using Hiranuma Sangyo's AQ-2000 Karl-Fischer Coulometric Titrator.

### (Measurement of Haze)

A sample of the film, 40 mm×80 mm was analyzed in an environment at 25° C. and at a relative humidity of 60&, using a haze meter (HGM-2DP, by Suga Test Instruments) and according to JIS K-6714.

The evaluation results are shown in Table 1.

TABLE 1

| | | Degree of Acyl | | | Polymer of Ethylenic Unsaturated Monomer | | | |
|---|---|---|---|---|---|---|---|---|
| | | Substitution of Cellulose | | | Ethylenic Unsaturated Monomer A | | Ethylenic Unsaturated Monomer B | |
| | | Acylate Base Layer | | | | polymerization | | polymerisation |
| | | acetyl | propionyl | total | type | ratio | type | ratio |
| Example 101 | Resin Film 101 | 2.85 | 0.00 | 2.85 | (101) | 100 | — | — |
| Example 102 | Resin Film 102 | 2.85 | 0.00 | 2.85 | (101) | 100 | — | — |
| Example 103 | Resin Film 103 | 2.85 | 0.00 | 2.85 | (101) | 100 | — | — |
| Example 104 | Resin Film 104 | 2.85 | 0.00 | 2.85 | (101) | 92 | (102) | 8 |
| Example 105 | Resin Film 105 | 2.85 | 0.00 | 2.85 | (101) | 92 | (102) | 8 |
| Example 106 | Resin Film 106 | 2.85 | 0.00 | 2.85 | (101) | 90 | (103) | 10 |
| Example 107 | Resin Film 107 | 2.85 | 0.00 | 2.85 | (101) | 90 | (103) | 10 |
| Example 108 | Resin Film 108 | 2.85 | 0.00 | 2.85 | (101) | 90 | (104) | 10 |
| Example 109 | Resin Film 109 | 2.85 | 0.00 | 2.85 | (101) | 90 | (104) | 10 |
| Example 110 | Resin Film 110 | 2.95 | 0.00 | 2.95 | (101) | 100 | — | — |
| Example 111 | Resin Film 111 | 1.60 | 0.80 | 2.40 | (101) | 90 | (104) | 10 |
| Example 112 | Resin Film 112 | 0.90 | 1.20 | 2.10 | (101) | 90 | (104) | 10 |
| Comparative | Resin Film 201 | 2.85 | 0.00 | 2.85 | — | — | — | — |
| Example 201 | | | | | | | | |
| Comparative | Resin Film 202 | 2.85 | 0.00 | 2.85 | N-vinyl-2-pyrrolidone^{b)} | 100 | — | — |
| Example 202 | | | | | | | | |
| Comparative | Resin Film 203 | 2.85 | 0.00 | 2.85 | N-vinyl-2-pyrrolidone^{b)} | 100 | — | — |
| Example 203 | | | | | | | | |
| Comparative | Resin Film 204 | 2.85 | 0.00 | 2.85 | (101) | 100 | — | — |
| Example 204 | | | | | | | | |
| Comparative | Resin Film 205 | 2.85 | 0.00 | 2.85 | (101) | 100 | — | — |
| Example 205 | | | | | | | | |
| Comparative | Resin Film 206 | 2.85 | 0.00 | 2.85 | (104) | 100 | — | — |
| Example 206 | | | | | | | | |
| Comparative | Resin Film 207 | 2.85 | 0.00 | 2.85 | N-vinyl-2-pyrrolidone^{b)} | 20 | methyl methacrylate | 80 |
| Example 207 | | | | | | | | |

| | | Polymer of Ethylenic | | | | |
|---|---|---|---|---|---|---|
| | | Unsaturated Monomer | | | Moisture | |
| | | weight- | | | Content] at | |
| | | average | Amount^{a)} | Photoelastic | 25° C. and | |
| | | molecular | added to | Coefficient | 80% RH | Haze |
| | | weight | base layer | ×10⁻¹² m²/N | (%) | (%) |
| Example 101 | Resin Film 101 | 1600 | 11 | 8.3 | 3.4 | 0.23 |
| Example 102 | Resin Film 102 | 1600 | 43 | 5.6 | 2.5 | 0.36 |
| Example 103 | Resin Film 103 | 1600 | 100 | 2.3 | 2.1 | 0.37 |
| Example 104 | Resin Film 104 | 5000 | 11 | 9.3 | 4.3 | 0.49 |
| Example 105 | Resin Film 105 | 6200 | 43 | 7.2 | 3.0 | 0.35 |
| Example 106 | Resin Film 106 | 3700 | 11 | 9.0 | 4.6 | 0.21 |
| Example 107 | Resin Film 107 | 3700 | 43 | 6.0 | 3.8 | 0.35 |
| Example 108 | Resin Film 108 | 3900 | 11 | 8.8 | 4.1 | 0.24 |
| Example 109 | Resin Film 109 | 3900 | 43 | 6.2 | 3.2 | 0.30 |
| Example 110 | Resin Film 110 | 1600 | 43 | 4.8 | 2.1 | 0.30 |
| Example 111 | Resin Film 111 | 3900 | 43 | 6.5 | 3.3 | 0.55 |
| Example 112 | Resin Film 112 | 3900 | 43 | 6.8 | 3.5 | 0.62 |
| Comparative | Resin Film 201 | — | 0 | 10.5 | 5.2 | 0.30 |
| Example 201 | | | | | | |
| Comparative | Resin Film 202 | 1000 | 11 | 9.3 | 6.51 | 3.7 |
| Example 202 | | | | | | |
| Comparative | Resin Film 203 | 1000 | 43 | 7.5 | 10.8 | 32.7 |
| Example 203 | | | | | | |
| Comparative | Resin Film 204 | 1600 | 0.5 | 10.4 | 5.1 | 0.27 |
| Example 204 | | | | | | |
| Comparative | Resin Film 205 | 1600 | 303 | This could not be peeled from the | | |
| Example 205 | | | | casting support as a film. | | |
| Comparative | Resin Film 206 | 20000 | 43 | 7.6 | 7.2 | 0.26 |
| Example 206 | | | | | | |
| Comparative | Resin Film 207 | 6000 | 43 | 6.8 | 3.1 | 15 |
| Example 207 | | | | | | |

^{a)}This is the amount added relative to 100 parts by mass of cellulose acylate.
^{b)}Exemplary compound in JP-A 2009-126899.

From the results in the above Table 1, it is known that the resin films of the invention, to which was added a polymer of an ethylenic unsaturated monomer having a cyano group in the molecule as the partial structure thereof, are all favorable, as having a small photoelastic coefficient and a small moisture content having a low haze.

Comparative Examples 202 and 203 are embodiments where a monomer shown in JP-A 2009-126899 was used alone, and Comparative Example 207 is an embodiment where a copolymer of two monomers used in Examples in JP-A 2009-126899; but all of these are inferior to the films of the invention in point of the above-mentioned performance.

Comparative Example 204 is an embodiment where polyacrylonitrile (polymer prepared through homopolymerization of the ethylenic unsaturated monomer (101)) was used as a mat agent in an amount generally used in the art, like in JP-A 2008-26881. However, it is known that the films of the invention, to which a polymer of an ethylenic unsaturated monomer having a cyano group as the partial structure in the molecule thereof was added in an amount of at least 1.5% by mass of the cellulose acylate therein, were improved more significantly in point of the above-mentioned performance than the film of Comparative Example 204 where the amount of the polymer was less than 1.5% by mass.

On the other hand, Comparative Example 205 is an embodiment, to which a polymer of an ethylenic unsaturated monomer having a cyano group as the partial structure in the molecule thereof was added in an amount of more than 300% by mass of the cellulose acylate therein, and this could not peeled away from the casting support as a film.

Comparative Example 206 is an embodiment where a homopolymer of the ethylenic unsaturated monomer (104) described in WO2008/126700 was used, but the film is inferior to the films of the invention in point of the above-mentioned performance thereof.

### (3) Production of Polarizer

### [Saponification Treatment of Polarizer Protective Film]

The polarizer protective film of Example 101 produced in the above was dipped in an aqueous solution of 2.3 mol/L sodium hydroxide at 55° C. for 3 minutes. This was washed in a water-washing bath at room temperature, and then neutralized with 0.05 mol/L sulfuric acid at 30° C. Again this was washed with a water-washing bath at room temperature and then dried with hot air at 100° C. Accordingly, the surface of the polarizer protective film of Example 101 was saponified.

### [Production of Polarizer]

A stretched polyvinyl alcohol film was made to adsorb iodine to prepare a polarizing element.

Using a polyvinyl alcohol adhesive, the saponified polarizer protective film of Example 101 was stuck to one side of the polarizing element. A commercially-available cellulose triacetate film (Fujitac TD80UF by FUJIFILM) was saponified in the same manner as above, and using a polyvinyl alcohol adhesive, the thus-saponified cellulose triacetate film was stuck to the other side of the polarizing element to which the polarizer protective film of Example 101 had been stuck.

In this, the polarizing element and the polarizer protective film of Example 101 were so arranged that the transmission axis of the former could be perpendicular to the slow axis of the latter. In addition, the polarizing element and the commercially-available triacetate film were also so arranged that the transmission axis of the former could be perpendicular to the slow axis of the latter.

In that manner, a polarizer of Example 101 was produced.

### [Saponification Treatment of Polarizer Protective Film and Production of Polarizer]

Using the polarizer protective films of Examples 102 to 112 and the polarizer protective films of Comparative Examples 201 to 207, polarizers of Examples and Comparative Examples corresponding thereto were produced according to the same process for saponification treatment and the process for polarizer production as in Example 101.

### Example 301

### Production of Liquid-Crystal Display Device

The viewers' side polarizer was peeled away from a commercially-available liquid-crystal television (SONY's Bravia J5000), and the polarizer of the invention comprising the polarizer protective film of Example 103 was stuck thereto using an adhesive, in such a manner that the polarizer protective film of Example 103 could face the liquid-crystal cell in the device. In this, the transmission axis of the viewers' side polarizer was set in the vertical direction. In addition, liquid-crystal display devices of Comparative Examples were produced in the same manner as herein except that the polarizer protective film of Comparative Examples 201 to 207 was used. Thus produced, the liquid-crystal display devices were left in an environment at 60° C. and at a relative humidity of 90% for 24 hours, and then checked for the display performance.

As compared with the liquid-crystal display devices using the polarizer protective film of Comparative Examples, the liquid-crystal display devices of the invention are good since the devices of the invention are free from the problem of display unevenness or since the area where display unevenness occurred in the devices of the invention is small.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2011-016780 filed on Jan. 28, 2011, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A resin film comprising:
a cellulose acylate and a polymer or an oligomer having a cyano group-comprising recurring unit in an amount of from 1.5 to 300% by mass of the cellulose acylate.

2. The resin film according to claim 1, wherein the weight-average molecular weight of the polymer or the oligomer having a cyano group-containing recurring unit is from 1000 to 100000.

3. The resin film according to claim 1, wherein the polymer or the oligomer having a cyano group-containing recurring unit consist of one or more different types of cyano group-containing recurring units.

4. The resin film according to claim 1, wherein the polymer or the oligomer having a cyano group-containing recurring unit comprises one or more different types of cyano group-containing recurring units and a recurring unit not containing a cyano group.

5. The resin film according to claim 1, wherein the cyano group-containing recurring unit includes a recurring unit derived from an ethylenic unsaturated monomer having a structure represented by the following formula (1): 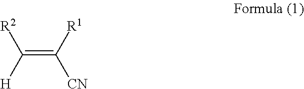
wherein R¹ and R² each independently represent a hydrogen atom, an alkyl group having from 1 to 6 carbon atoms, a halogen atom, a cyano group, an alkoxy group having from 1 to 6 carbon atoms, an acyl group having from 1 to 6 carbon atoms, —NH—COOH, an acylamino group having from 1 to 6 carbon atoms, or a carbamoyl group.

6. The resin film according to claim 5, wherein R¹ in the Formula (1) is a hydrogen atom, a methyl group, an ethyl group, a chlorine atom or a cyano group.

7. The resin film according to claim 5, wherein R² in the Formula (1) is a hydrogen atom, a methyl group or a cyano group.

8. The resin film according to claim 5, wherein the ethylenic unsaturated monomer is methacrylonitrile.

9. The resin film according to claim 5, wherein the cyano group-containing recurring unit is a recurring unit derived from an ethylenic unsaturated monomer having the structure represented by the formula (1).

10. The resin film according to claim 1, wherein the polymer or oligomer has only one type of a cyano group-containing recurring unit.

11. The resin film according to claim 1, wherein the polymer or oligomer further has a recurring unit derived from an ethylenic unsaturated monomer having a structure represented by the following formula (2): 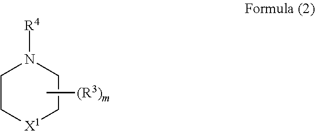
wherein R³ represents a hydrogen atom, an oxygen atom, a halogen atom, an aliphatic group optionally having a substituent, an aromatic group optionally having a substituent, or a heterocyclic group optionally having a substituent; m indicates an integer of from 0 to 8, and when m is from 2 to 8, R³'s may be the same or different; R⁴ represents a group having an ethylenic unsaturated bond as the partial structure thereof; and X¹ represents an oxygen atom or a sulfur atom.

12. The resin film according to claim 1, wherein the polymer or oligomer further has a recurring unit derived from an ethylenic unsaturated monomer having a structure represented by the following formula (3): 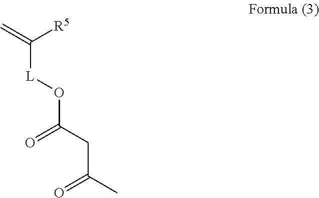
wherein R⁵ represents a hydrogen atom, an aliphatic group optionally having a substituent, an aromatic group optionally having a substituent or a heterocyclic group optionally having a substituent; L represents a single bond, or a divalent aliphatic group optionally having a substituent, a divalent aromatic group optionally having a substituent, a divalent heterocyclic group optionally having a substituent, —C(═O)—, —O—, —N(R⁶)— or a combination thereof; R⁶ represents a hydrogen atom or an alkyl group.

13. The resin film according to claim 1, wherein the polymer or oligomer further has a recurring unit derived from an ethylenic unsaturated monomer having a structure represented by the following formula (4): 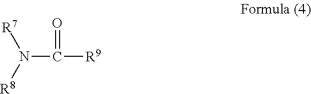
wherein R⁷, R⁸ and R⁹ each independently represent an aliphatic group optionally having a substituent, an aromatic group optionally having a substituent, or a heterocyclic group optionally having a substituent; any two of R⁷, R⁸ and R⁹ may bond to each other to form a cyclic structure along with the nitrogen atom, or the nitrogen atom and the carbon atom to which they bond.

14. The resin film according to claim 1, wherein the total degree of acyl substitution of the cellulose acylate is from 2.00 to 2.95.

15. The resin film according to claim 1, wherein the total degree of acyl substitution of the cellulose acylate is from 2.70 to 2.95.

16. The resin film according to claim 1, of which the absolute value of the photoelastic coefficient is at most 10×10⁻¹² m²/N.

17. The resin film according to claim 1, of which the haze is at most 1% and the moisture content at 25° C. and at a relative humidity of 80% is at most 5%.

18. A polarizer protective film using a resin film comprising:
a cellulose acylate and
a polymer or an oligomer having a cyano group-comprising recurring unit in an amount of from 1.5 to 300% by mass of the cellulose acylate.

19. A polarizer containing a polarizing element and at least one polarizer protective film, wherein the polarizer protective film is a resin film comprising:
a cellulose acylate and
a polymer or an oligomer having a cyano group-comprising recurring unit in an amount of from 1.5 to 300% by mass of the cellulose acylate.

20. A liquid-crystal display device containing at least one polarizer protective film, wherein the polarizer protective film is a resin film comprising:
a cellulose acylate and
a polymer or an oligomer having a cyano group-comprising recurring unit in an amount of from 1.5 to 300% by mass of the cellulose acylate.
